(19) United States
(12) Patent Application Publication
(10) Pub. No.: US 2011/0191688 A1
(43) Pub. Date: Aug. 4, 2011

(54) NETWORK SYSTEM, SERVER APPARATUS, AND COMPUTER-READABLE STORAGE MEDIUM

(75) Inventors: Nobuhiko HASEGAWA, Tokyo (JP); Tomomi Gojo, Kanagawa (JP); Takahiro Nozaki, Kanagawa (JP)

(73) Assignee: RICOH COMPANY, LTD., Tokyo (JP)

(21) Appl. No.: 13/018,768

(22) Filed: Feb. 1, 2011

(30) Foreign Application Priority Data
Feb. 4, 2010 (JP) 2010-023355

(51) Int. Cl. G06F 3/01; G06F 15/16

(52) U.S. Cl. 715/738

(57) ABSTRACT

A server apparatus provides groupware functions by storing data to be attached to an image object in correspondence with a window on which image object is to be displayed at a client terminal so that all data attached to the image object are storable regardless of any one of a plurality of windows on which the image object is displayed. The server apparatus inherits and stores data attached to an image object moved or copied at the client terminal, in correspondence with the user data attached to a seat image to which the image object is moved or copied and a second window that is specified by the user data attached to the seat image and displayed at the client terminal, in response to an update request from the client terminal.

### CROSS-REFERENCE TO RELATED APPLICATIONS

This application claims the benefit of a Japanese Patent Application No. 2010-023355 filed on Feb. 4, 2010, in the Japanese Patent Office, the disclosure of which is hereby incorporated by reference.

### BACKGROUND OF THE INVENTION

1. Field of the Invention

The present invention generally relates to network systems, server apparatuses, and computer-readable storage media that stores a groupware program.

2. Description of the Related Art

Recently, groupware environments have become popular, thereby making it possible to smoothly transfer and share information. For example, in an office environment in a corporation, for example, the groupware system is utilized to improve the work efficiency. In the groupware system (or collaboration system), various tools and various functions, such as mail, message, notice-board, schedule management, task (or To-Do) management, and presence management are provided, so that a user may manage, transfer, and share information in units of the individual or in units of group members. Such a groupware system may generally be formed by a server apparatus that provides the functions of the groupware system, and a plurality of client terminals that are connected to the server apparatus via a network and are utilized by the users.

Various kinds of information is processed in the groupware system described above. Hence, it may be useful to facilitate access to information useful to the user. More particularly, it may be useful to modify or improve the graphical operations or the user-centered interactive operations of a UI (User Interface), the variety or diversity of information, and the interaction of information among the plurality of functions.

As an example, a Japanese Patent No. 4057171 proposes an information management system that may synchronize a personal information management system that manages schedules, work items, addresses, and request items of each of workers within a group, and groupware information that is managed by the groupware system, in order to improve the variety or diversity of the information. The groupware system centrally manages the information conventionally managed by the personal information management system, and access to various information useful to the user may be made from the groupware.

On the other hand, a Japanese Laid-Open Patent Publication No. 2004-310272 proposes a group work support apparatus that provides a discussion place on the network to efficiently advance the group work, in order to improve the graphical operations or the user-centered interactive operations of the UI, for example. The discussion place may represent speech contents of participants in a tag format, and the position or coloring of the tag may be changed in order to easily identify or classify the speech contents.

However, according to the information management system proposed in the Japanese Patent No. 4057171, when synchronizing the necessary items other than the work items, the request items and the like, each system (or software) that manages the corresponding personal information must cope with the synchronization. In addition, it is a precondition that a redundant management is employed. Hence, operations are essentially required in a plurality of kinds of systems (or software), and it may be difficult to provide simple and easy user operations.

The groupware system may also manage the personal information such as the schedules, work items, and request items. However, because the functions related to the schedules, the work items, and the request items are realized independently, each function may not be utilized in a single simple operation. For example, the items displayed in a function view such as the notice-board and the schedule have predetermined data and format depending on each function view. For this reason, if it is necessary to set information in one function view based on information of another function view, the information must be set in one function view even though the same contents have already been set in the other function view. For example, if it is necessary to set the user's schedule based on the information indicated on the notice-board, the user must input the user's schedule information again while confirming the contents indicated on the notice-board. In other words, if a different function is to be utilized within the same groupware, the information setting operation must be performed a plurality of times, and it may be difficult to improve the graphical operations or the user-centered interactive operations of the UI, the variety or diversity of information, and the interaction of information among the plurality of functions.

On the other hand, according to the group work support apparatus proposed in the Japanese Laid-Open Patent Publication No. 2004-310272, only a single function is provided, and the proposed group work support apparatus merely aims to improve the graphical operations or the user-centered interactive operations of the UI within the single function. Needless to say, the collaboration of the group work is not limited to a discussion function, and from the point of view of the individual (or member) participating in the discussion, the discussion is simply a single event in the group work. In other words, there is no continuity between the discussion function and the other group work functions, and the interaction of information among the plurality of functions may not be improved. Consequently, the load associated with preparations and the like for the discussion function may be a burden on the user who wishes to utilize the discussion function.

### SUMMARY OF THE INVENTION

Accordingly, it is a general object in one embodiment of the present invention to provide a novel and useful network system, server apparatus, and computer-readable storage medium, in which the problem described above may be suppressed.

Another and more specific object in one embodiment of the present invention is to provide a network system, a server apparatus, and a computer-readable storage medium, that may improve user operation and interaction of various information among groupware functions. As an example, the various information (for example, presence information, message, etc.) utilized by each function of the groupware may be managed to provide a seamless interaction or link of the functions, in order to realize efficient information sharing and consistent operation.

According to one aspect of the present invention, there is provided a network system including a server apparatus, including a first processor and a storage unit, configured to provide a plurality of groupware functions; and a client terminal, communicatably coupled to the server apparatus, including a second processor and a display unit, wherein the storage unit includes a first storage part configured to store first information related to a window in which a corresponding groupware function is realized, second information related to an image object to be displayed in an overlapping manner on the window, and data to be attached to the image object in correspondence with the window on which image object is to be displayed in the overlapping manner, so that all data attached to the image object are storable within data items in the first storage part regardless of any one of a plurality of windows on which the image object is displayed; and a second storage part configured to store third information related to a seating chart window in which a corresponding groupware function is realized, fourth information related to a seat image to be displayed in an overlapping manner on the seating chart window, and user data to be attached to the seat image; the first processor includes a transmitting part configured to transmit to the client terminal the first and second information and the data stored in the first storage part, and the third and fourth information and the user data stored in the second storage part; the second processor includes a window display part configured to display a first window on the display unit based on the first information received from the server apparatus; an image object display part configured to display the image object on the display unit in an overlapping manner on the first window based on the second information received from the server apparatus; a seating chart window display part configured to display the seating chart window on the display unit based on the third information received from the server apparatus; a seat image display part configured to display the set image on the display unit in an overlapping manner on the seating chart window based on the fourth information received from the server apparatus; an operation part configured to move or copy the image object displayed on the first window to the seat image displayed on the seating chart window in response to a move or copy instruction; and an update request part configured to make an update request for the data attached to the image object with respect to the server apparatus when the image object is moved or copied to the seat image by the operation part; wherein the image object display part displays the moved or copied image object on the display unit in an overlapping manner on a second window that is specified by the user data attached to the seat image, together with the data attached to the image object, as message information; and the first storage part of the server apparatus inherits and stores the data attached to the moved or copied image object, in correspondence with the user data attached to the seat image to which the image object is moved or copied and the second window, in response to the update request from the client terminal.

According to another aspect of the present invention, there is provided a server apparatus communicatable with at least one client terminal via a network, including a storage unit; and a processor configured to provide a plurality of groupware functions, wherein the storage unit includes a first storage part configured to store first information related to a window in which a corresponding groupware function is realized, second information related to an image object to be displayed in an overlapping manner on the window, and data to be attached to the image object in correspondence with the window on which image object is to be displayed in the overlapping manner, so that all data attached to the image object are storable within data items in the first storage part regardless of any one of a plurality of windows on which the image object is displayed; and a second storage part configured to store third information related to a seating chart window in which a corresponding groupware function is realized, fourth information related to a seat image to be displayed in an overlapping manner on the seating chart window, and user data to be attached to the seat image; the processor includes a transmitting part configured to transmit to the client terminal the first and second information and the data stored in the first storage part, and the third and fourth information and the user data stored in the second storage part; and the first storage part inherits and stores data attached to an image object moved or copied at the client terminal, in correspondence with the user data attached to the seat image to which the image object is moved or copied and a second window that is specified by the user data attached to the seat image and displayed at the client terminal, in response to an update request from the client terminal.

According to still another aspect of the present invention, there is provided a computer-readable storage medium which stores a groupware program which, when executed by a computer of a server apparatus, causes the computer to perform a process to provide a plurality of groupware functions to at least one client terminal via a network, the process including a first storage procedure causing the computer to store, in a first storage part of a storage unit, first information related to a window in which a corresponding groupware function is realized, second information related to an image object to be displayed in an overlapping manner on the window, and data to be attached to the image object in correspondence with the window on which image object is to be displayed in the overlapping manner, so that all data attached to the image object are storable within data items in the first storage part regardless of any one of a plurality of windows on which the image object is displayed; a second storage procedure causing the computer to store, in a second storage part of the storage unit, third information related to a seating chart window in which a corresponding groupware function is realized, fourth information related to a seat image to be displayed in an overlapping manner on the seating chart window, and user data to be attached to the seat image; and a transmitting procedure causing the computer to transmit to the client terminal the first and second information and the data stored in the first storage part, and the third and fourth information and the user data stored in the second storage part, wherein the first storage procedure causes the computer to inherit and store data attached to an image object moved or copied at the client terminal, in correspondence with the user data attached to the seat image to which the image object is moved or copied and a second window that is specified by the user data attached to the seat image and displayed at the client terminal, in response to an update request from the client terminal.

Other objects and further features of the present invention will be apparent from the following detailed description when read in conjunction with the accompanying drawings.

### BRIEF DESCRIPTION OF THE DRAWINGS

FIG. 1 is a diagram illustrating an example of a network structure of a groupware system in an embodiment of the present invention;

FIG. 2 is a block diagram illustrating an example of a hardware structure of a server apparatus in the embodiment of the present invention;

FIG. 3 is a block diagram illustrating an example of a hardware structure of a client terminal in the embodiment of the present invention;

FIG. 4 is a block diagram illustrating an example of a functional structure of the server apparatus and the client terminal in the embodiment of the present invention;

FIG. 5 is a diagram illustrating an example of a structure of functional components of the server apparatus in the embodiment of the present invention;

FIG. 6 is a diagram illustrating an example of a basic screen of a groupware;

FIG. 7 is a diagram illustrating an example of a tag create screen for creating a tag;

FIGS. 8A and 8B are diagrams illustrating an example of a structure of tag data;

FIG. 9 is a diagram illustrating an example of a seating chart window;

FIG. 10 is a diagram illustrating an example of a seating chart create screen;

FIG. 11 is a diagram illustrating the example of the seating chart window;

FIG. 12 is a diagram illustrating an example of a data structure of a seating chart property;

FIG. 13 is a diagram illustrating an example of a seat create screen;

FIG. 14 is a diagram illustrating the example of the seating chart window;

FIG. 15 is a diagram illustrating an example of a data structure of user information;

FIG. 16 is a diagram illustrating an example of a data structure of seating data;

FIG. 17 is a diagram illustrating an example of a seating content display screen;

FIG. 18 is a diagram illustrating an example of a selection list of a presence selection;

FIG. 19 is a diagram illustrating the example of the seating chart window;

FIG. 20 is a diagram illustrating an example of a seating chart utilization selection screen;

FIG. 21 is a diagram illustrating an example of a basic screen of the groupware for explaining a tag transmitting operation utilizing the seating chart;

FIG. 22 is a diagram illustrating an example of a message window;

FIG. 23 is a diagram illustrating an example of a post creating or editing screen;

FIG. 24 is a diagram illustrating an example of a display of a post arranged on a top screen; and

FIG. 25 is a diagram for explaining the interaction between the message view and other function views.

### DESCRIPTION OF THE PREFERRED EMBODIMENTS

A description will be given of embodiments of the network system, the server apparatus, and the computer-readable storage medium according to the present invention, by referring to the drawings. In one embodiment of the present invention, the present invention is applied to a groupware system.

[System Structure]

(Network)

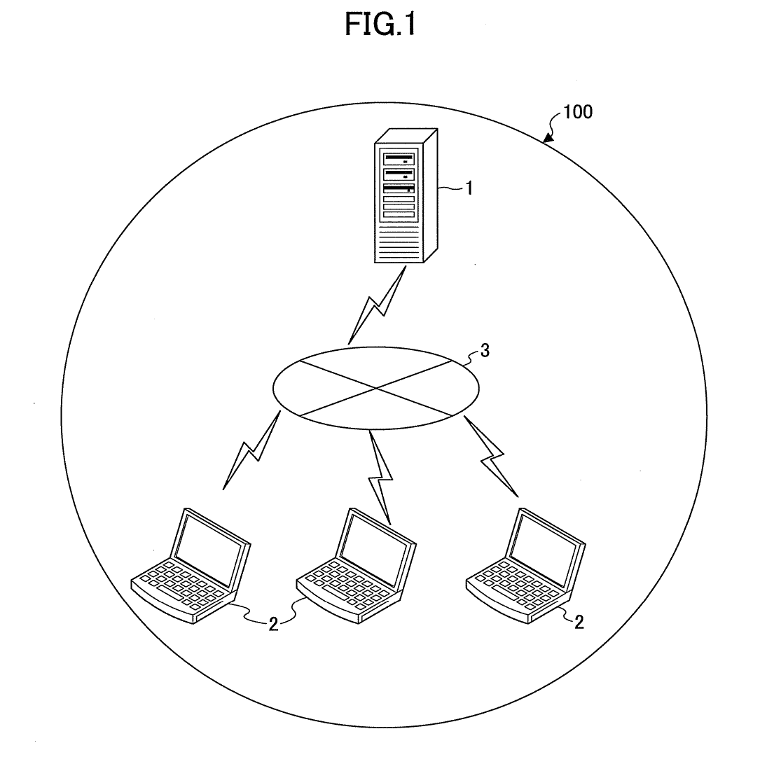

FIG. 1 is a diagram illustrating an example of a network structure of the groupware system in the embodiment of the present invention. A groupware system 100 illustrated in FIG. 1 includes a server apparatus 1 and a plurality of client terminals 2 that are communicatably connected via a network 3.

The server apparatus 1 forms a groupware server. The server apparatus 1 includes a DB (Data-Base) and the like, and provides various groupware functions (or groupware features) to the client terminals 2. Each client terminal 2 forms a so-called user terminal. The client terminals 2 may share information via the server apparatus 1. The client terminal 2 may be formed by a PC (Personal Computer) or any suitable information processing equipment such as a PDA (Personal Digital Assistant) and a portable telephone. The network 3 may include at least one of a cable network and a wireless network. The network 3 may be formed by a LAN (Local Area Network) or a WAN (Wide Area Network), for example.

FIG. 1 merely illustrates one example of the network structure in the embodiment, and the server apparatus 1 and the client terminals 2 may be communicatably connected to different networks as long as the client terminals 2 may access the server apparatus 1 via the different networks or vice versa. Of course, internal function parts which will be described later and the DB of the server apparatus 1 may be included in another server apparatus that is connected to the network 3.

(Hardware of Server Apparatus)

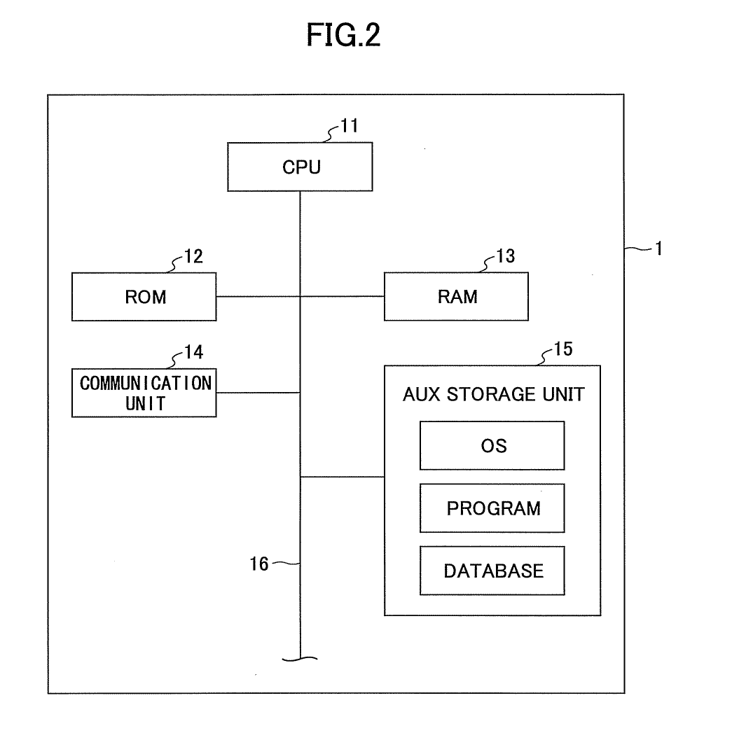

FIG. 2 is a block diagram illustrating an example of a hardware structure of the server apparatus in the embodiment of the present invention. The server apparatus 1 illustrated in FIG. 2 includes a CPU (Central Processing Unit) 11, a ROM (Read Only Memory) 12, a RAM (Random Access Memory) 13, a communication unit 14, and an auxiliary storage unit 15 that are connected via a bus line 16.

The CPU 11 includes a microprocessor and peripheral circuits, and executes various programs to perform various information processing, operation processes (or computing processes), and control processes to control each part of the server apparatus 1 and the entire server apparatus 1.

The ROM 12 may store basic programs and control programs that run on the server apparatus 1, and parameters used by the programs. The RAM 13 may form a work area that is used by various processes and operations that are performed when the CPU 11 executes one or more programs stored in the ROM 12 or the auxiliary storage unit 15.

The communication unit 14 enables communication between the server apparatus 1 and each of the client terminals 2 via the network 3.

The auxiliary storage unit 15 may be formed by a nonvolatile storage unit having a relatively large storage capacity, such as a HDD (Hard Disk Drive). The auxiliary storage unit 15 may store programs for realizing various operations, and various data, and the data may be stored in the form of the DB. For example, the programs may include a basic program, such as an OS (Operating System) that operates the server apparatus 1, a control program that controls the communication unit 14, a groupware program for realizing a groupware system, and other programs. The DB may form an information DB for use by the groupware system of this embodiment, for example. The CPU 11 executes the groupware program, and generates screen data, such as function views and tags (or electronic tags), to be provided to the client terminals 2. Information from the client terminals 2 may be stored in the DB of the server apparatus 1.

The server apparatus 1 may further include a display unit (not illustrated) and an input device (not illustrated), such as a keyboard and a mouse. For example, the display unit and the input device may be used when performing server management or when attending to a maintenance of the server apparatus 1.

(Hardware of Client Terminal)

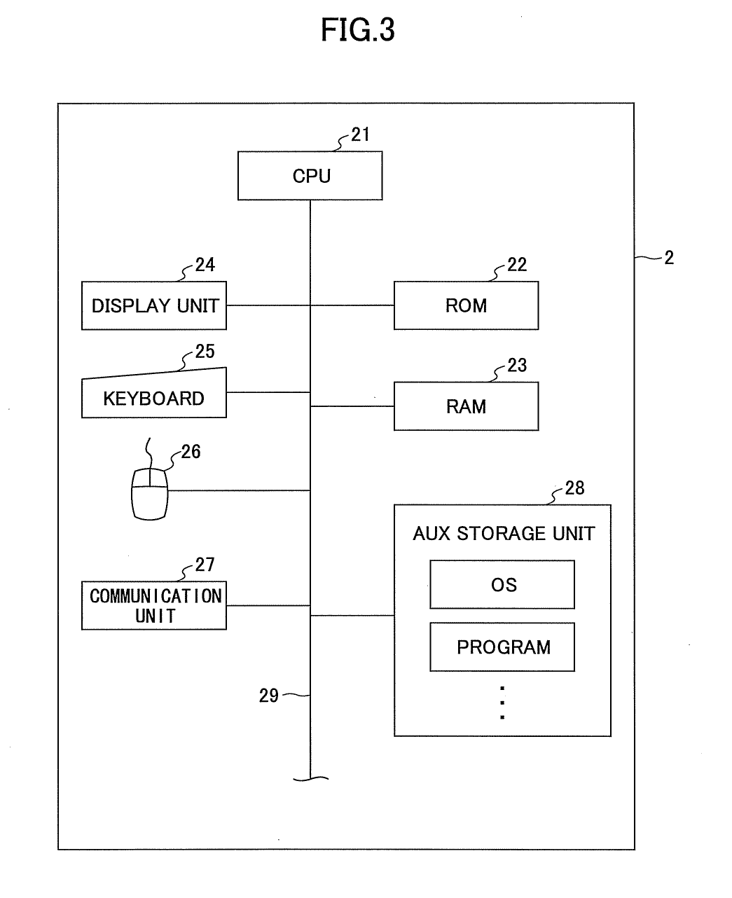

FIG. 3 is a block diagram illustrating an example of a hardware structure of the client terminal in the embodiment of the present invention. The client terminal 2 illustrated in FIG. 3 includes a CPU 21, a ROM 22, a display unit 24, a keyboard 25, a mouse 26, a communication unit 27, and an auxiliary storage unit 28 that are connected via a bus line 29.

The CPU 21 includes a microprocessor and peripheral circuits, and executes various programs to perform various information processing, operation processes (or computing processes), and control processes to control each part of the client terminal 2 and the entire client terminal 2.

The ROM 22 may store basic programs and control programs that run on the client terminal 2, and parameters used by the programs. The RAM 23 may form a work area that is used by various processes and operations that are performed when the CPU 21 executes one or more programs stored in the ROM 22 or the auxiliary storage unit 28.

The display unit 24 may be formed by a CRT (Cathode Ray Tube), a LCD (Liquid Crystal Display), a plasma display or the like. The display unit 24 displays characters and images which may be input by the user, and screens which may be defined by screen data of tags and function views transmitted from the server apparatus 1.

The keyboard 25 includes alphanumeric keys for inputting characters, numerals, and symbols, and various function keys such as space, delete, and back-space keys. Character information and numerical value information may be input or, the functions may be specified, from the keyboard 25 by pushing the various keys. In this example, the keys of the keyboard 25 may be pushed by the user to input tag contents and names and the like of the various function views.

The mouse 26 forms a pointing device. When the mouse 26 is moved by the user, a mouse pointer or the tag displayed on the display unit 24 move therewith. In addition, the mouse 26 may include a left button and a right button. By pushing the button of the mouse when the mouse pointer points an image object such as the tag, icon, radio button, check box, and combo box, the function corresponding to the pointed image object is selected. The image object may be a screenshot or screen capture. In this example, the mouse 26 may be used to perform operations on the screens of the image objects, such as the tag, icon, radio button, check box and combo box, and the various function views provided by the server apparatus 1.

The communication unit 27 enables communication between the client terminal 2 to which the communication unit 27 belongs, and the server apparatus 1 via the network 3. The communication unit 27 receives the screen data of the function views and the tags from the server apparatus 1, and transmits the data input by the user to the server apparatus 1.

The auxiliary storage unit 28 may be formed by a nonvolatile storage unit having a relatively large storage capacity, such as a HDD (Hard Disk Drive). The auxiliary storage unit 28 may store various programs and data. For example, the programs may include a basic program, such as an OS (Operating System) that operates the client terminal 2, a control program that controls the communication unit 27, viewing programs (for example, a Web browser program and a dedicated viewing (or viewer) program) for utilizing the groupware services provided by the server apparatus 1, a Japanese Kana-Kanji character conversion program, and other programs. The viewing programs realize the viewer functions of the groupware.

When the Web browser is used as the viewing program, the CPU 21 displays a browser screen on the display unit 24 by the browser function. The browser screen may include a URL (Uniform Resource Locator) input field for inputting a URL that specifies a Web site at a connecting destination, and displays screens defined by the screen data transmitted from the server apparatus 1. The CPU 21 may connect the client terminal 2 to the Web site specified by the URL that is input to the URL input field, and translate the screen data received from the server apparatus 1 to display on the browser screen the screens of the function views and the tags, using the browser function.

In addition, the CPU 21 may transmit information input by the user from the browser screen to the server apparatus 1, using the browser function. For example, by clicking the image object, such as the tag, icon, radio button, check box, and combo box, displayed on the browser screen by a mouse operation, the CPU 21 may transmit a signal indicating the selected image object to the server apparatus 1 or, the CPU 21 may transmit the character information input from the input field of the browser screen to the server apparatus 1. In addition, by specifying various files on the browser screen, the CPU 21 may transmit the specified files stored in the auxiliary storage unit 28 to the server apparatus 1. For example, the specified files include image files, text files, and files to be used by applications (or application software) for word processing, spreadsheet or the like, that are stored in the auxiliary storage unit 28.

By executing the Web browser program by the CPU 21, the user may transmit and receive information bi-directionally between the client terminal 2 and the server apparatus 1. In this example, the CPU 21 may use the browser function to provide various groupware functions that are provided by the server apparatus 1.

(Functions of Server Apparatus and Client Terminal)

Next, a description will be given of the functions of the server apparatus 1 and the client terminal 2 in this embodiment. Because the server apparatus 1 forms the groupware server as described above, the server apparatus 1 may provide the various groupware functions to the client terminals 2 that are connected to the server apparatus 1 via the network 3. For example, the client terminal 2 makes access to the server apparatus 1 to request the function views to be displayed on the display unit 24, such as “notice-board”, “schedule”, “matrix”, “seating chart”, and “message”. The user may perform operations on each function view displayed on the display screen of the display unit 24, in order to carry out individual or group work using the client terminal 2 while performing information management, information transfer, information sharing and the like in units of the individual or units of group members.

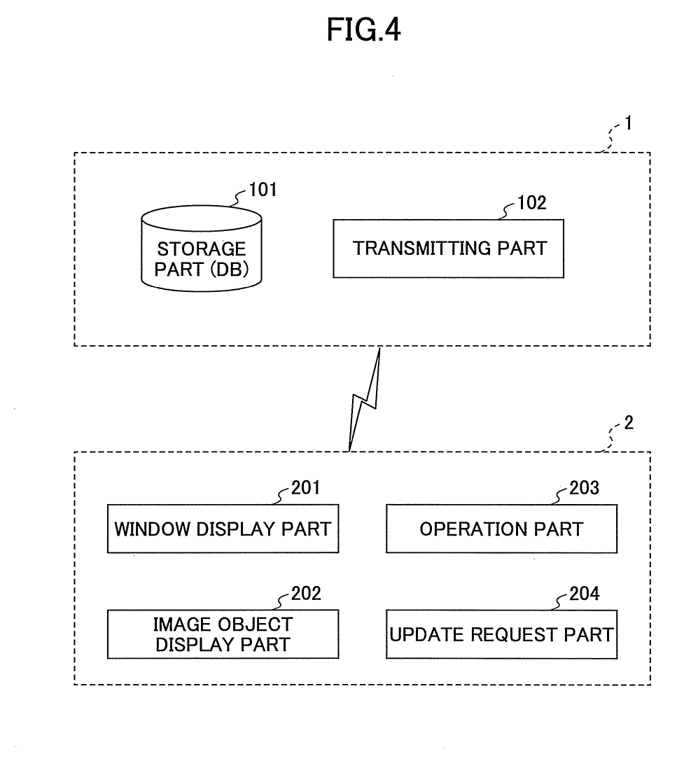

FIG. 4 is a block diagram illustrating an example of a functional structure of the server apparatus and the client terminal in the embodiment of the present invention. As illustrated in FIG. 4, the server apparatus 1 has a functional structure including a storage part 101 and a transmitting part 102. On the other hand, the client terminal 2 has a functional structure including a display part 201, an image object display part 202, an operation part 203, and an update request part 204. Of course, the server apparatus 1 includes various general functions to realize the groupware functions, but illustration of the various general functions is omitted in FIG. 4 for the sake of convenience. Similarly, the client terminal 2 includes various general functions to utilize the groupware functions, but illustration of the various general functions is omitted in FIG. 4 for the sake of convenience.

The storage unit 101 of the server apparatus 1 includes a function to store information related to windows providing work fields for realizing the groupware functions, information related to the image objects to be displayed in an overlapping manner on the windows, and data attached to the image objects. For example, the windows include the windows of the various function views, and the data attached to the image objects include data information bound to the tags. In other words, the storage part 101 stores the display information and data necessary to utilize the groupware functions by the client terminal 2. The display information and data stored in the storage part 101 is sent to the client terminal 2, and is displayed on the display screen in a display format that enables the user to easily utilize the groupware functions.

The storage part 101 stores the data attached to the image object in correspondence with the window on which the image object is to be displayed in the overlapping manner, and all of the data attached to the image object is storable within the data item regardless of which one of the plurality of windows on which the data attached to the image object is to be displayed in the overlapping manner. More particularly, because each function view has a role originally intended therefor, different information is requested for each function view. In the case of the function view of the schedule (function view “schedule”), for example, time information is essential. However, in the case of the function view of the matrix (function view “matrix”), the time information is not necessarily essential, and position information indicating the importance of the task is more essential than the time information. Accordingly, when the DB is formed by the storage part 101, the DB has a schema structure that enables storage of all data to be saved, regardless of the function view on which the image object is arranged in the overlapping manner. Hence, even in the case of the image object on the function view “schedule” or the like, the data structure in the DB enables storage of not only the time information for the function view “schedule” but also the position information indicating the importance of the task for the function view “matrix”. Of course, the data value itself only requires the time information and does not require the position information, as long as the image object is arranged on the function view “schedule” or the like in the overlapping manner. As a result, the various information utilized in each function view may be utilized in a seamless manner, for each of the function views, as will be described later in more detail. In the following description, it is assumed for the sake of convenience that the DB is formed by the storage part 101.

The storage part 101 stores various information for forming the function view “seating chart”. The function view “seating chart” is one of the functions within the groupware (that is, a function tool) that enables confirmation of a presence or seated state (for example, present, not in seat, out, etc.) of the member through the use of the seating chart. Hence, the various information for forming the function view “seating chart” includes information related to a seating chart window for realizing the groupware functions, information related to a seat image to be displayed within the function view “seating chart” in an overlapping manner on the seating chart window, and data attached to a seat image. More particularly, the information related to the seating chart window includes information for forming and displaying the function view “seating chart”. The data attached to the seat image includes data (for example, user ID, position or attachment information, presence status, etc.) of the user who is specified by the seat image and belongs to the seat.

The data attached to the tag and the data attached to the seat image may be stored in separate storage region of a single storage part, such as the storage part 101 or, in mutually different, separate storage parts.

The transmitting part 102 includes a function to send to the client terminal 2 the information stored in the storage part 101, including the information related to the windows, the information related to the image objects, and the data attached to the image objects. The information and data transmitted to the client terminal 2 is displayed on the display screen in a display format that enables the user to easily and conveniently utilize the groupware functions. Similarly, the various information for forming the function view “seating chart”, such as the information related to the seating chart window, the information related to the seat image, and the data attached to the seat image, is also transmitted to the client terminal 2. Hence, the user may utilize the function view “seating chart” at the client terminal 2.

The display part 201 of the client terminal 2 includes a function to display a plurality of windows on the display unit 24, for example, based on the information related to the windows transmitted from the server apparatus 1. For example, the function views “notice-board”, “schedule”, “matrix”, and “message” are displayed on the display unit 24 of the client terminal 2. The display 24 of the client terminal 2 may simultaneously display a plurality of function views. The user uses the function views displayed on the screen of the client terminal 2 in order to perform the information management, the information transfer, the information sharing and the like in units of the individual or units of group members. Similarly, the display part 201 of the client terminal 2 displays the seating chart window on the display unit 24, for example, based on the information related to the seating chart window transmitted from the server apparatus 1. In addition, the display part 201 displays the seat image in an overlapping manner on the seating chart window on the display unit 24, based on the information related to the seat image. Hence, the function view “seating chart” is displayed, and the seat image of each user is displayed on the seating chart.

The image object display part 202 includes a function to display the image object in an overlapping manner on the window on the display unit 24, for example, based on the information related to the image object transmitted from the server apparatus 1. As an example, the “tag” is displayed on each function view, as the image object. In the case of the “notice-board” function view, the tag holds notice information to be indicated on the notice-board. In the case of the “schedule” function view, the tag holds the schedule information to be managed for the individual user or the user group. In the case of the “matrix” function view, the tag holds task information to be managed for the individual user or the user group.

The operation part 203 includes a function to move or copy the image object on the window displayed on the display unit 24, from the position on the window to a position on the seat in the seating chart window. Hence, the tag on the plurality of function views displayed on the screen of the client terminal 2 may be moved or copied to the position on the seat in the seating chart window, by the move or copy operation. When performing the move or copy operation, the data attached to the tag, including the plurality of data items, is inherited (or succeeded) and stored in a manner also utilizable in the function view (for example, the message view) at the destination of the move or copy, as will be described later in more detail.

The update request part 204 includes a function to make an update request for the data attached to the image object, with respect to the server apparatus 1, when the move or copy operation is performed to move or copy the image object to the position on the seat in the seating chart window. When the update request is made, the storage part 101 of the server apparatus 1 stores the data attached to the image object into the data item, in correspondence with the window at the more or copy destination, while inheriting and storing the data attached to the image object that is subjected to the move or copy operation. As an example, when the move or copy operation is performed to move or copy the tag (that is, the image object) from a memo pad or the like to the position on the seat in the seating chart window, the data attached to the tag is stored into the data item in correspondence with the message view at the move or copy destination while inheriting and storing the data attached to the tag as it is, as will be described later in more detail.

Of course, the functions described above may be realized by a computer by executing the programs by the CPU 11 and the CPU 21 described above.

(Function Component)

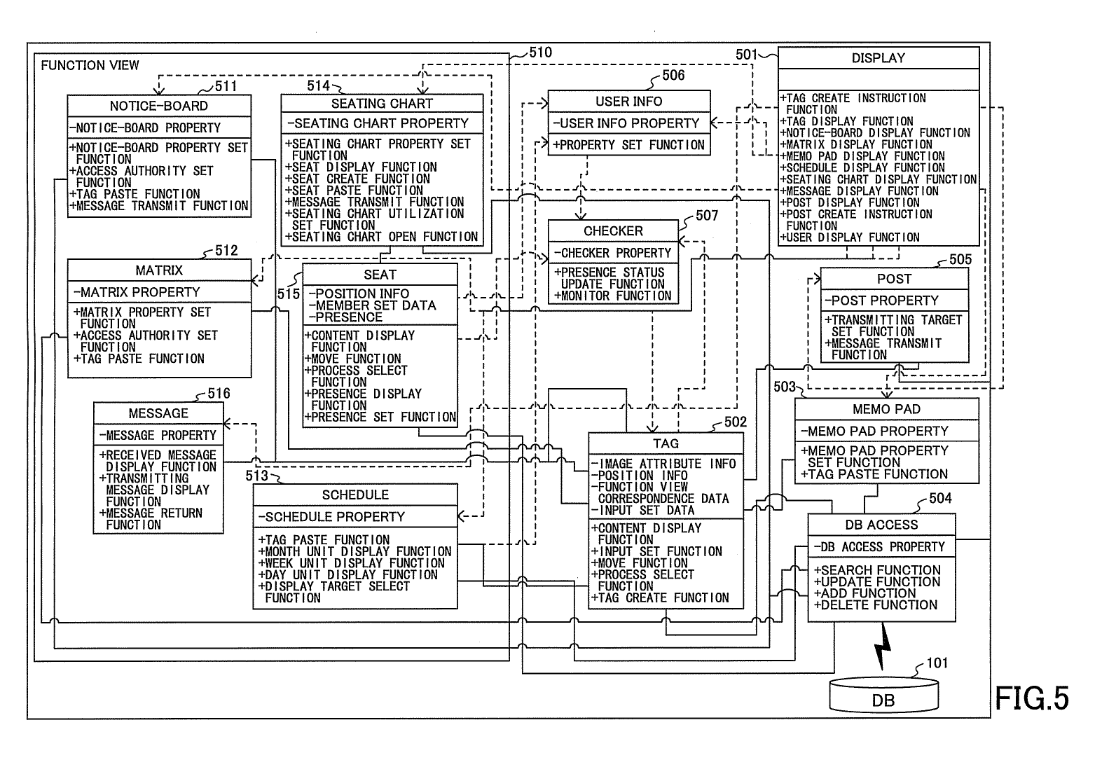

Next, a description will be given of the function components installed in the server apparatus 1 in the embodiment of the present invention, by referring to FIG. 5. FIG. 5 is a diagram illustrating an example of a structure of the functional components of the server apparatus in the embodiment of the present invention.

The server apparatus 1 in this embodiment includes the following function components (or function programs) in order to realize the functions of the function parts described above. As an example, the server apparatus 1 provides the function views “notice-board”, “schedule”, “matrix”, “seating chart”, and “message” to the client terminal 2, however, the function views that are provided are not limited to such, and other function views related to the groupware may be provided. In FIG. 5, each block indicates the data (or data name) of each function component in an upper portion thereof, and the processing functions (or processing function names) performed by each function component in a lower portion thereof.

A display component 501 performs a screen control related to input and output with respect to the client terminal 2, and a general display of the basic screen (or basic window) of the groupware functions. Various operation instructions with respect to the various function components are issued via the operations performed on the basic screen displayed by the display component 501. For example, the user performs an operation on the basic screen to issue a tag create instruction with respect to a tag component 502, or issues a seating chart display instruction with respect to a seating chart component 514, in order to generally utilize the groupware functions provided by the server apparatus 1.

The tag (or image object) component 502 creates the tag (or image object) to be freely arranged on the various function views or the memo pad, displays the attached information contents, performs an operation (for example, a move operation) on the tag image between the function view and the memo pad, and controls the data setting and the like associated with the operation. The data attached to the tag will be described later in more detail.

A memo pad component 503 displays a memo pad field, as a temporary work field to temporarily hold the tag (or image object). Because the tag may be freely pasted on the memo pad, the memo pad may be utilized as an adjusting space for the information prior to being arranged on the function view or, as a storage location for the To-Do list whose details have not been determined.

A DB access component 504 performs a search, update, add, and delete processes on the data, with respect to the DB formed by the storage part 101 that stores the data, in response to the requests from the other components.

A post component 505 displays a post create screen which will be described later in order to preset the post name and the user who is the transmitting target, and displays a post tag transmission confirmation screen in order to select the user who is the transmitting target and to transmit the tag. The post component 505 is similar to a post box that receives mail, because the tag (or image object) may be posted by drag-and-drop operation.

A user information component 506 is created when registering the user in the groupware system 100, and sets a user information property (or registered information) in the possession of the individual user. The setting contents of the user information component 506 may be reflected to a seat component 515, a schedule component 513 or the like.

A checker component 507 monitors a planned action category in the tag data and the presence status of the user information component 506 or the presence status of the seat component 515, and sets an appropriate presence status.

A function view includes a notice-board component 511, a matrix component 512, the schedule component 513, the seating chart component 514, the seat component 515, and a message component 516. As described above, other function components may be included in the function view 510 depending on the groupware functions.

The notice-board component 511 creates the notice-board as a constituent element of the groupware functions, and sets a user authority on the viewing and operation. The notice-board may be utilized as an information notice-board (or information bulletin board) by arranging (or pasting) the tag (or image object) on the notice-board.

The matrix component 512 creates a matrix of the groupware functions, and forms a constituent element of the function view on the basic screen. The matrix may be utilized for the task management or the like, by arranging (or pasting) on the matrix the tag of the task information to be performed.

The schedule component 513 displays the schedule of the groupware functions. The schedule may be utilized for the schedule management or the like, by arranging the tag on a schedule chart having a calendar format in units of days, weeks, months or years. The schedule component 513 may transmit the tag of the schedule chart, as a message, to the individual user or the user group. In addition, the schedule component 513 may select the schedule chart, in order to select and display a display target such as the schedule of the individual user, the schedule of other users, and the schedule of the user group.

The seating chart component 514 creates and displays the seating chart and the seats in the seating chart of the groupware functions, transmits the message (for example, tag) with respect to the seat, and sets the seating chart property (for example, a seating chart name, a sharing setting, etc.).

The seat component 515 displays and moves the seat contents (including the presence status) of each user in the seating chart of the groupware functions.

The message component 516 displays a list of messages (for example, tags) transmitted to other users and tags received from other users, confirms the received tags, and replies to the received tags.

Next, a more detailed description will be given of the hardware structure and the function blocks of the server apparatus 1 and the client terminal 2 of the groupware system 100, and the function components of the server apparatus 1, in conjunction with example screens.

### Example 1

### Summary

A description will be given of the summary of the groupware (basic screen, function view, memo pad, tag, and tag data) and the general tag operation (create, edit, move, etc.) for the example 1. A description in conjunction with the function view will be described later.

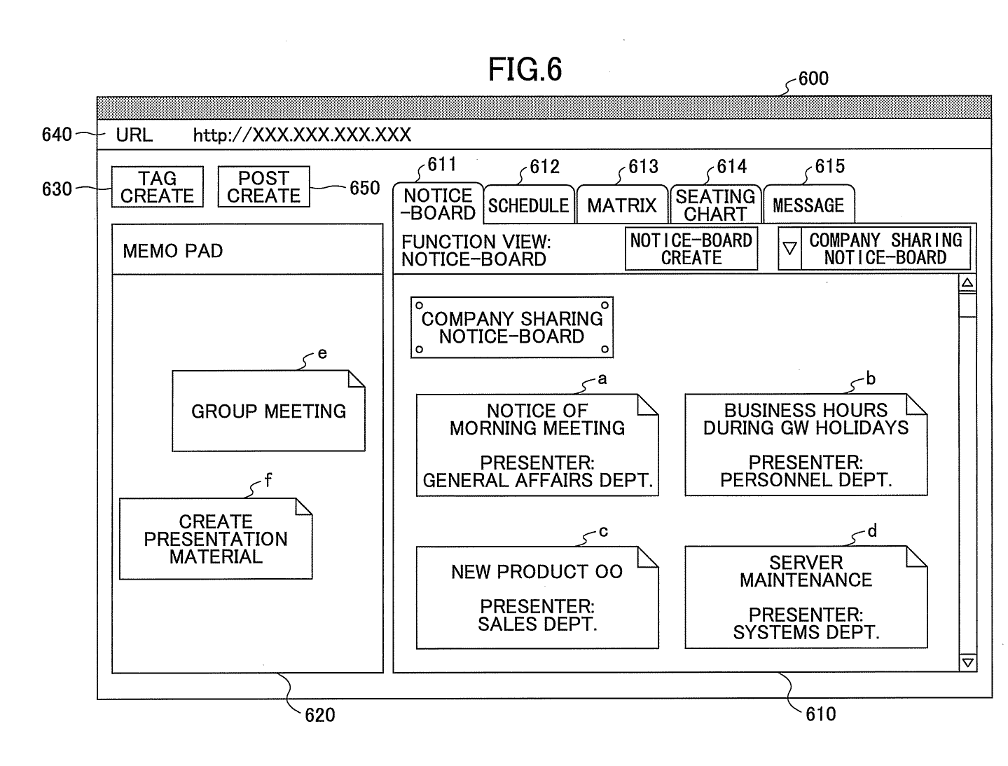

FIG. 6 is a diagram illustrating an example of the basic screen of the groupware in this example. The user at the client terminal 2 may generally utilize the groupware functions by performing operations on a basic screen 600. Hence, the user may utilize the groupware functions provided by the server apparatus 1, including information viewing and information posting on a notice-board 611, schedule management of individual user or user group in a schedule 612, task management in a matrix 613, a presence management in a seating chart 614, and exchange of messages in a message 615.

When the Web browser is used as the viewing program of the client terminal 2, the browser screen is displayed on the display unit 24 as the basic screen 600. In this case, the basic screen (browser screen) 600 includes a URL input field 640 to input a URL that specifies the Web site at the connecting destination, and the screen defined by the screen data transmitted from the server apparatus 1 is displayed on the display unit 24.

The basic screen 600 generally includes a function view window 610, and a memo pad window 620. The function view window 610 forms a main window that enables utilization of the groupware functions provided by the server apparatus 1, while switching the various function views or, while simultaneously displaying the various function views. FIG. 6 illustrates an example in which the function views of the notice-board 611 are displayed, and tags “a” through “d” are posted as posted items within the window of the notice-board 611. Because a plurality of notice-boards may be created, the notice-boards may be switched by a switching operation in order to display the target notice-board. The function views other than the notice-board 611, such as the schedule 612, the matrix 613, the seating chart 614, and the message 615 may be selected by selecting the corresponding tabs, in order to switch the function view displayed in the function view window 610. Of course, instead of using the tabs for selecting the function views, a multi-window format may be employed to simultaneously display windows of the function views, so that the target function view may be selected by selecting the corresponding window.

The memo pad window 620 may be utilized as a temporary work field to temporarily hold (or save) the tag. Because the memo pad may provisionally hold the tag that is newly created or, moved or copied from the function view, the memo pad may be utilized as the adjusting space for the information prior to being arranged on the function view or, as the storage location for the To-Do list whose details have not been determined. In the memo pad window 620 illustrated in FIG. 6, tags “e” and “f” are held in the memo pad window 620, and the tags “e” and “f” may be moved or copied to positions on the various function views.

A tag create icon 630 illustrated in FIG. 6 is selected when newly creating a tag, and the new tag is created, as an image object, on the function view or memo pad. A post create icon 650 is selected when newly creating a post icon, and the new post icon is created in the function view “seating chart” or in the upper portion of the basic screen 600. When the tag is dropped on the post icon by a drag-and-drop operation, the message of the tag is transmitted to the set destination, as will be described later.

(Creating Tag)

In this example, the tag (or electronic tag) forms an information transfer medium to transfer the information processed by the groupware. Generally, a tag may be a small piece of paper, which may have an adhesive portion, used to sort documents, for example. Information may be written on the paper tag, and the paper tag may be freely adhered to and removed from various places in the documents. Hence, in this example, the tag is used in a manner similar to the paper tag in order to simulate the paper tag, but in an electronic manner. In other words, this example applies the image of the paper tag to the tag that forms the information transfer medium for the groupware, in order to improve the UI and the operation ease by enabling user-centered interactive operations to utilize the groupware. Of course, the tag is merely an example of the image object, and the image object is not limited to the tag.

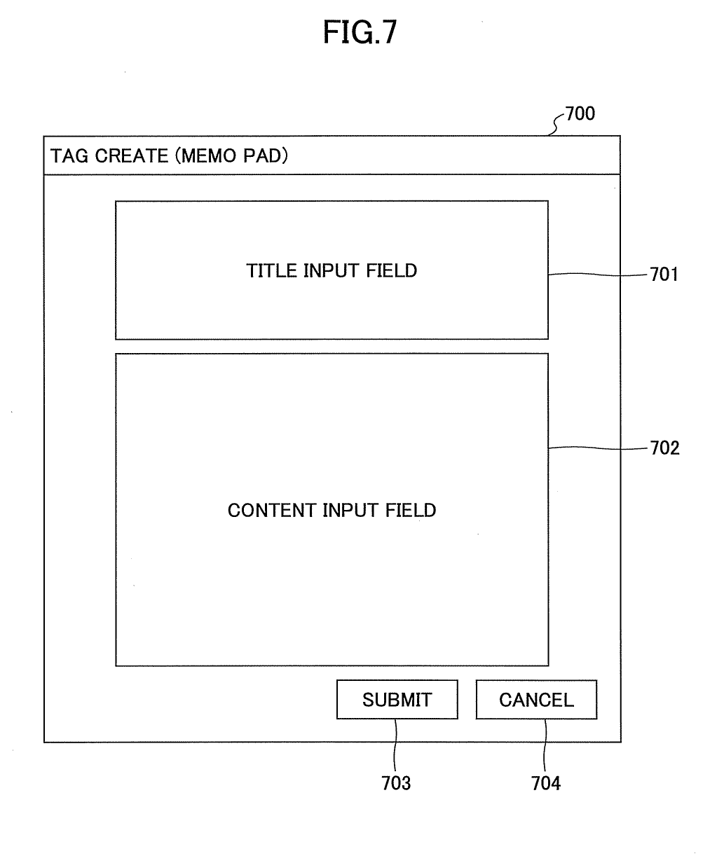

FIG. 7 is a diagram illustrating an example of a tag create screen for creating the tag. When creating the tag, the user selects the tag create icon (or button) 630 on the display screen of the client terminal 2 illustrated in FIG. 6, by a click of the left button of the mouse 26 (hereinafter referred to as a left-click), for example. In response to this selection, a tag create screen 700 illustrated in FIG. 7 is displayed on the display unit 24, for example. When the user inputs information to a title input field 701 and a content input field 702 and selects a submit button 703, a tag is created and registered. The created tag is pasted and displayed on the work field on the function view or the memo pad 620.

For example, the function view or the memo pad 620 on which the created tag is to be arranged may be specified by the pointing device that specifies the target or, may be specified within the tag create screen 700. The tag create operation is cancelled when a cancel button 704 is selected on the tag create screen 700.

FIG. 7 illustrates the tag create screen 700 for a case where the created tag is arranged on the memo pad 620. However, essential items to be input on the tag create screen 700 may differ depending on the function view on which the created tag is to be arranged. Thus, the tag create screen may differ depending on the function view on which the created tag is to be arranged, as will be described later.

The tag create operation may be performed using a tag create instruction function and a tag display function of the display component 501, a tag create function and a content display function, an input set function of the tag component 502, the function view components 511 through 513 of the function view 501, and a tag pasting function of the memo pad component 503, in the function component structure illustrated in FIG. 5. In addition, the tag data may be registered in the DB of the storage part 101 by an add function of the DB access component 504.

(Tag Data)

Next, a description will be given of the data attached to the created tag (or image object), that is, the tag data.

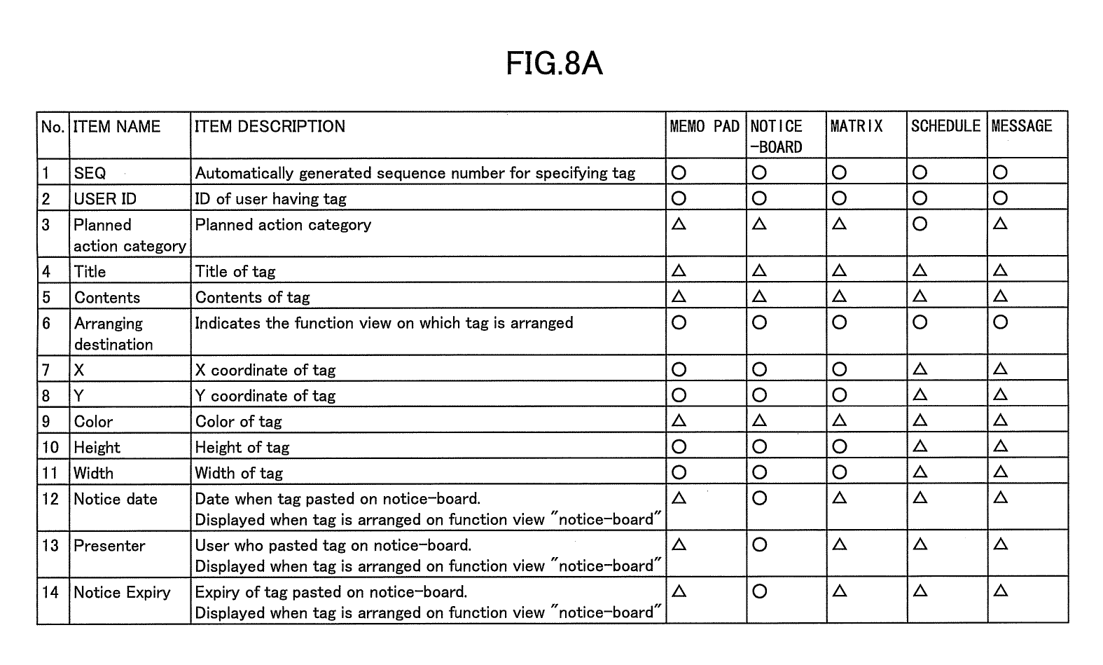

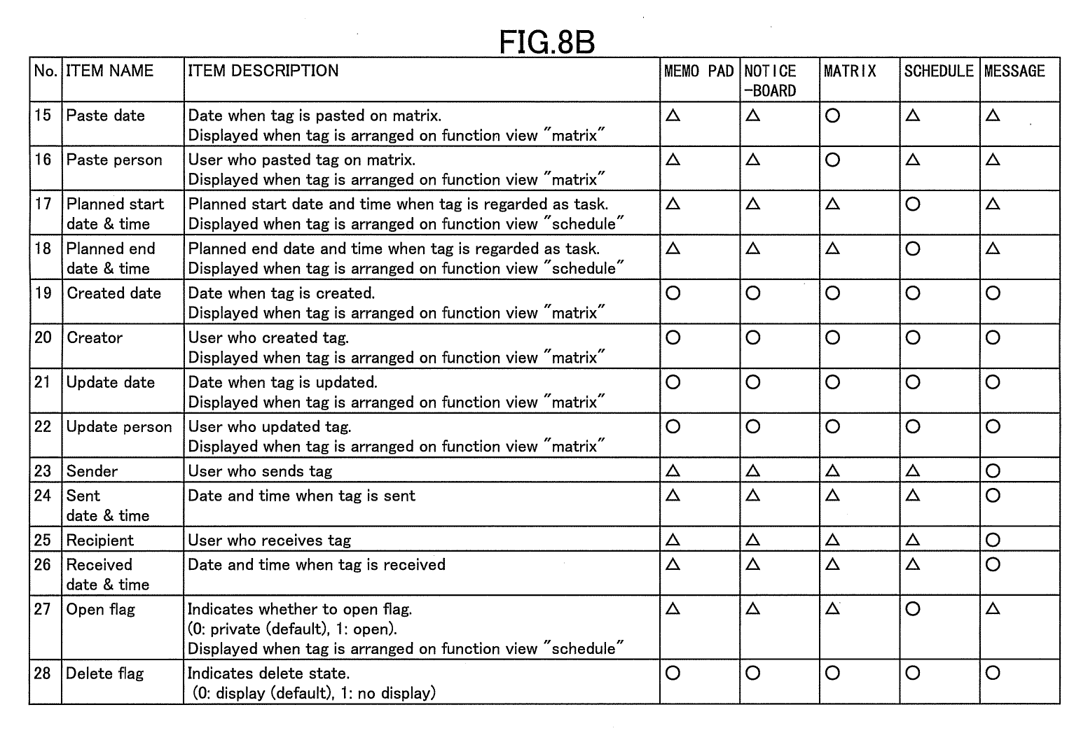

FIGS. 8A and 8B are diagrams illustrating an example of a structure of the tag data that is created by the tag component 502. In FIGS. 8A and 85, a symbol “◯” indicates essential information, and a symbol “Δ” indicates arbitrary information. The tag in this example may be created and arranged on any of the function views and the memo pad, and thus, the tag has a data structure that enables all of the data items to be stored so that the tag may be arranged on any work field. When one tag is created on the tag create screen 700 described above, the data is stored in the data items in the DB of the storage part 101 for each tag.

The data structure of the tag data illustrated in FIGS. 8A and 8B includes “item name (or data item name”, “item description”, “memo pad”, “notice-board”, “matrix”, “schedule”, and “message”. The “item name” indicates the name of each data item, and the “item description” indicates the description of the item. The “memo pad”, “notice-board”, “matrix”, “schedule”, and “message” indicate whether each item (or data item) is essential or arbitrary (or option) in each function view on which the tag may be arranged. For example, item Nos. 7, 8, 10 and 11 denote data items indicating values of the arranging position and shape (or size) of the tag on the work field, and the information of these data items are essential in the function views “memo pad”, “notice-board” and “matrix” because it is otherwise impossible to determine the work field on which the tag is to be arranged and the size of the tag to be arranged. On the other hand, as will be described later, the tag is arranged within the schedule chart having the calendar format in units of days, weeks, months or years for the “schedule” function view, and thus, these data items are non-essential and the data items may be arbitrary for the “schedule” function view. In addition, as will be described later, the tag is arranged (or stored) within the message list for the “message” function view, and thus, these data items are non-essential and the data items may be arbitrary for the “message” function view. The data items being arbitrary for the function views “schedule” and “message” means that the value itself of each arbitrary data item is not referred to (or used), but that the arbitrary data item may hold a certain value. The display of each item (or data item) may be controlled in a display format corresponding to each function view or memo pad, by each function view component 510 or memo pad component 503.

The data structure of the tag illustrated in FIGS. 8A and 8B does not include the data items that are essential or arbitrary when the tag is arranged on the “seating chart” function view, because the tag may not be maintained as it is when arranged on the “seating chart” function view. In other words, when the tag is dropped on the seat icon by the drag-and-drop operation, the tag is transmitted as a message to the user who is specified by the seat, and it is unnecessary to restrict the data items to be included in the tag when the tag is arranged on the “seating chart” function view, as will be described later.

For example, when the tag is created on the memo pad, values are set in at least the item Nos. 1, 2, 6-8, 10, 11, 19-22 and 29 denoting the data items that are essential in the tag data in FIGS. 8A and 8B. In addition, if information is input to the title input field 701 and the content input field 702 in FIG. 7, values are also set in the data items denoted by the items Nos. 4 and 5. The tag data is registered in the DB of the storage part 101 by the add function of the DB access component 504. For example, the data items denoted by the item Nos. 7, 9, 10, 11 and 26 are essential in the tag data, but predetermined values may be set as default values when creating the tag. The default values may be modified later if necessary. In addition, the data items denoted by the item Nos. 1, 2, 6 and 19-22 do not need to be directly input by the user, and may be automatically acquired and input.

The other “item names” and the description in the “item description” of the data structure illustrated in FIGS. 8A and 8B will be described later in conjunction with the example operations.

(Editing Tags and Example Operation of Content Display)

Returning now to the description of FIG. 6, when editing the tag created within the memo pad window 620 or the function view window 610 or, when displaying the contents of the tag, the user may perform a double-left-click operation using the mouse 26, for example, with respect to the tags “a” through “f” illustrated in FIG. 6. In this case, the tag create screen 700 illustrated in FIG. 7 is displayed. The information is already input to the title input field 701 and the content input field 702 because the tag is being edited.

When editing the tag, the user edits the title input field 701 and the content input field 702, and selects the submit button 703 in order to reflect the edited contents to the tag. The tag edit operation is performed using the tag display function of the display component 501, and the content display function and the input set function of the tag component 502 in the function component structure illustrated in FIG. 5. For example, at least the item Nos. 4, 5, 21 and 22 in the data structure of the tag data illustrated in FIGS. 8A and 8B are updated, and the tag data in the DB of the storage part 101 is updated by an update function of the DB access component 504.

When displaying the contents of the tag, the user may perform a double-left-click operation using the mouse 26, for example, with respect to the tags “a” through “f” illustrated in FIG. 6. In this case, the tag create screen 700 illustrated in FIG. 7 is displayed. The information is already input to the title input field 701 and the content input field 702 because the tag contents are being displayed, and the user confirms the displayed contents of the tag. In addition, when the cancel button 704 is selected on the tag create screen 700, the tag create screen 700 may be closed. The content display operation to display the contents of the tag may be performed using the tag display function of the display component 501, the content display function of the tag component 502, and a search function of the DB access component 504 in the function component structure illustrated in FIG. 5.

(Moving Tags and Example Operation of Copy)

When moving the tag, the user may perform a drag-and-drop operation using the mouse 26, for example, with respect to the tags “a” through “f” illustrated in FIG. 6, in order to move the tag by a drag operation and to drop the tag at an arbitrary move destination by a drop operation. The same operation, such as the drag-and-drop operation, may be performed to move the tag within one of the function views 611 through 615, within the memo pad 620, or between two of the memo pad 602 and the function views 611 through 615. For example, when moving the tag between two of the function views 611 through 615, the move operation is performed by simultaneously displaying the function views 611 through 615. The move operation may be performed using a move function of the tag component 502 and a tag paste function of the function view 510 or a tag paste function of the memo pad component 503 in the function component structure illustrated in FIG. 5. In addition, at least the item numbers Nos. 6 (if moving the tag within the function view or within the memo pad), 7, 8, 21 and 22 in the data structure of the tag data illustrated in FIGS. 8A and 8B are updated, and the tag data in the DB of the storage part 101 is updated by the update function of the DB access component 504.

When copying the tag, the user may perform a click operation using the right button of the mouse 26 (hereinafter referred to as a right-click), for example, with respect to the tags “a” through “f” illustrated in FIG. 6, in order to display a menu box. The menu box may include buttons “copy”, “paste”, and “delete”, for example, that may be selected in order to select an operation instruction content with respect to the tag. The user selects the button “copy”, displays the menu window again by performing a right-click operation using the mouse 26 at an arbitrary move destination, and selects the button “paste”, to thereby copy the tag. The copy operation may be performed using a process select function of the tag component 502 and the tag paste function of the function view 510 or the tag paste function of the memo pad component 503 in the function component structure illustrated in FIG. 5. In addition, the item numbers Nos. 2, 4, 5, 9-18, 26 and 28 in the data structure of the tag data illustrated in FIGS. 8A and 8B are copied, the item numbers Nos. 1, 6-8 and 19-22 are newly set, and the new tag data in the DB of the storage part 101 is registered by the add function of the DB access component 504.

(Example Operation of Tag Delete)

When deleting the tag, the user may perform a right-click operation using the mouse 26, for example, with respect to the tags “a” through “f” illustrated in FIG. 6, in order to display the menu box. The menu box may include buttons “copy”, “paste”, and “delete”, for example, that may be selected in order to select an operation instruction content with respect to the tag. The user selects the button “delete” in order to delete the tag that was displayed up to that point in time, and the tag is no longer displayed after being deleted. The delete operation may be performed using the tag display function of the display component 501 and the process select function of the tag component 502 in the function component structure illustrated in FIG. 5. In addition, a delete flag of the item number No. 28 in the data structure of the tag data illustrated in FIG. 8B is set to “1: No Display”, and the tag data in the DB of the storage part 101 is updated by a delete function of the DB access component 504. The tag data whose delete flag is set to “1: No Display” may be deleted from the DB of the storage part 101 after a predetermined time elapses.

The summary of the groupware (basic screen, function view, memo pad, tag, and tag data) and the general tag operation (create, edit, move, etc.) for the example 1 of the embodiment are as described above. For this reason, using the groupware, the operation related to the tag may be performed with the same (or a common) operation ease regardless of whether the tag is arranged on the function view or the memo pad within the basic screen.

### Example 2

### Interaction of Seating Chart and Message View

Next, a description will be given of the “seating chart” function view and the “message” function view.

(Example Operation of Creating Seating Chart)

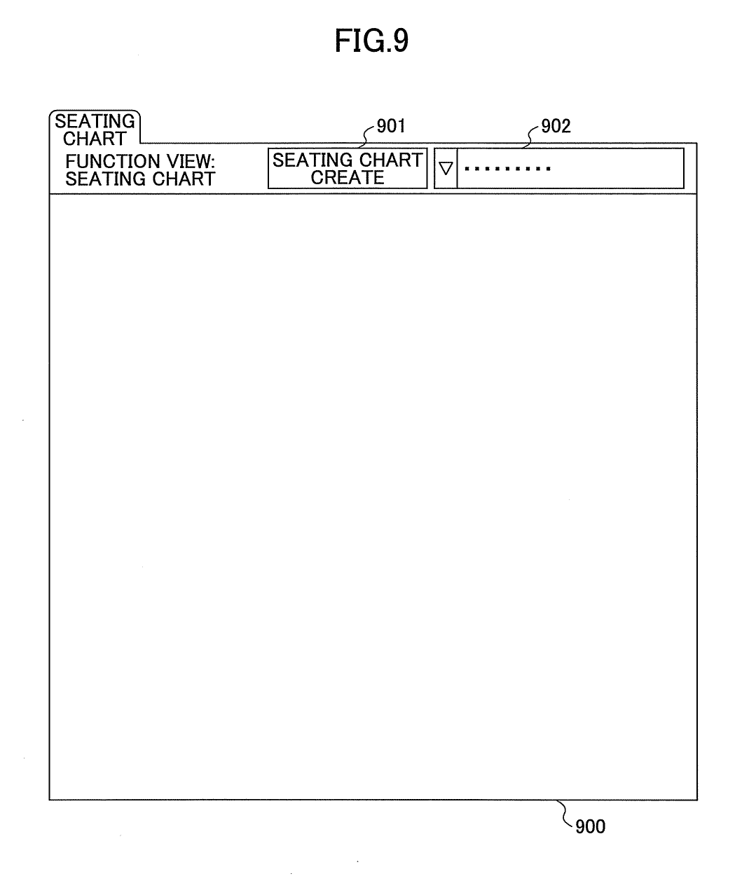

FIG. 9 is a diagram illustrating an example of a seating chart window. A seating chart window 900 illustrated in FIG. 9 is in an initial state where no seating chart has been created. When creating a new seating chart, the user may perform a left-click operation using the mouse 26, for example, with respect to a seating chart create button 901 provided within the seating chart window 900. On the other hand, if a seating chart has already been created, the user may select the seating chart from a selection box 902 in order to display the selected seating chart.

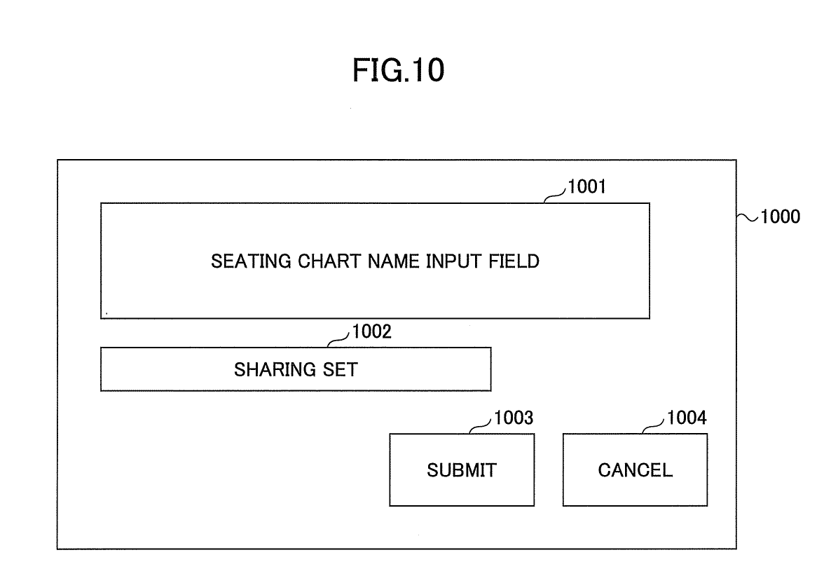

When creating the new seating chart, the user may perform a left-click operation using the mouse 26, for example, with respect to the seating chart create button 901 within the function view “seating chart”, in order to display a seating chart create screen 1000 illustrated in FIG. 10. FIG. 10 is a diagram illustrating an example of the seating chart create screen. The user inputs the name of the seating chart to be created into a seating chart name input field 1001 on the seating chart create screen 1000. The name of the seating chart may be input arbitrarily, and if a name “usergroup02” is input, for example, it is possible to create a seating chart to be used by a user group 02.

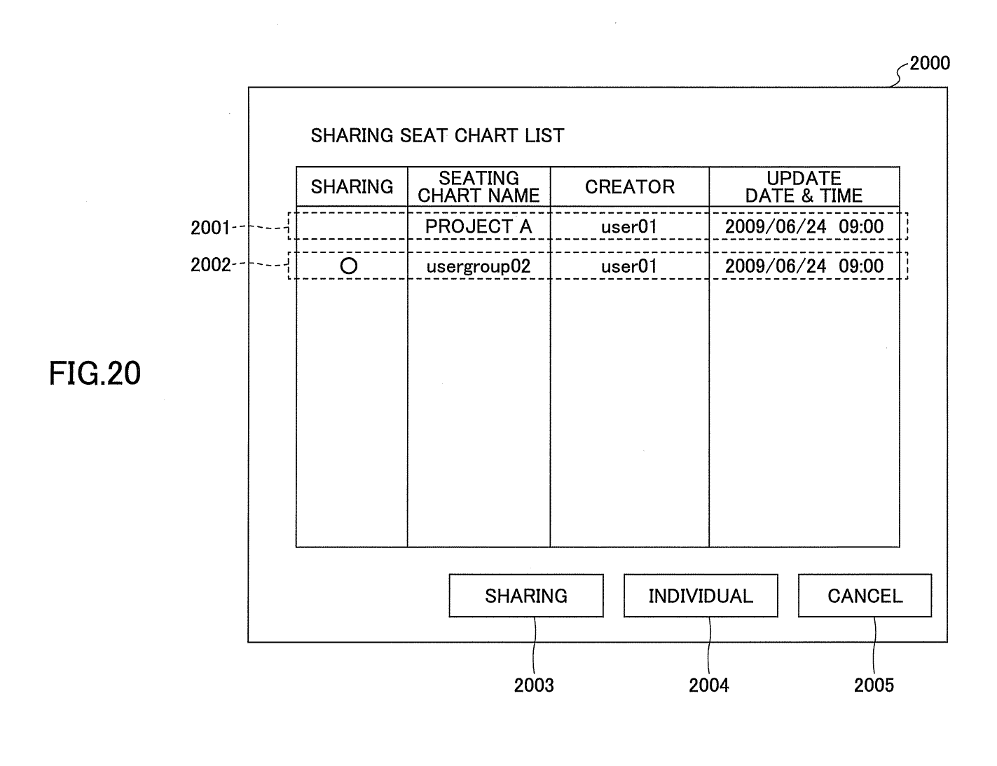

A sharing set button 1002 is used to set the seating chart that is being created for “sharing” or for “non-sharing”. The “non-sharing” seating chart will be referred to as a local seating chart, and the “sharing” seating chart will be referred to as a sharing seating chart. The user may set the seating chart name, create seats, modify the seating arrangement or layout, and delete the seats in the local seating chart. On the other hand, the sharing seating chart may share the seating chart name and the seating arrangement with other users. Only the user who created the sharing seating chart may perform an edit process with respect to the sharing seating chart, such as modifying the seating arrangement and deleting the seats in the sharing seating chart. Users other than the user who created the sharing seating chart may not perform the edit process with respect to the sharing seating chart, such as modifying the seating arrangement and deleting the seats in the sharing seating chart. When the sharing set button 1002 is selected to set the seating chart to “sharing”, the sharing seating chart is registered as a sharable candidate on a seating chart utilization selection screen which will be described later in conjunction with FIG. 20.

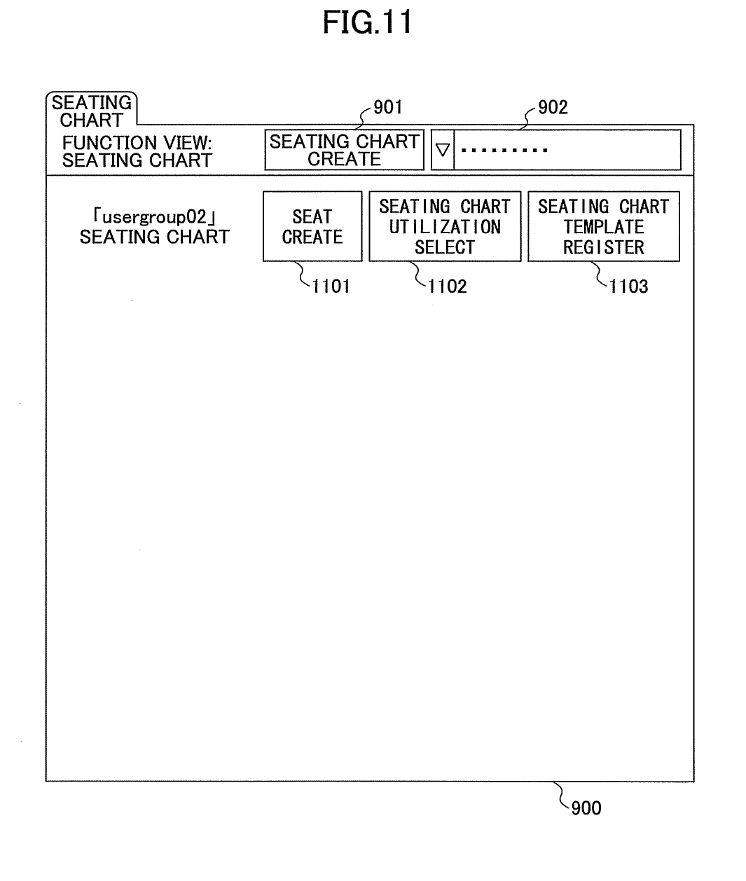

After the setting is completed and the user selects a submit button 1003 on the seating chart create screen 1000, the seating chart create screen 1000 is closed, and the new seating chart is created and displayed within the seating chart window 900 as illustrated in FIG. 11. FIG. 11 is a diagram illustrating the example of the seating chart window. But at this point in time, the seat of each user is not yet created, and the seats are not yet displayed in the seating chart. On the other hand, if the user selects a cancel button 1004 on the seating chart create screen 1000, the seating chart create screen 1000 is closed, and the seating chart create operation is cancelled.

The seating chart create operation may be performed using a seating chart display function of the display component 501, and a seating chart property set function of the seating chart component 514 in the function component structure illustrated in FIG. 5. Thus, a seating chart property of the seating chart component 514 is set, and finally, the new seating chart is registered in the DB of the storage part 101 by the add function of the DB access component 504.

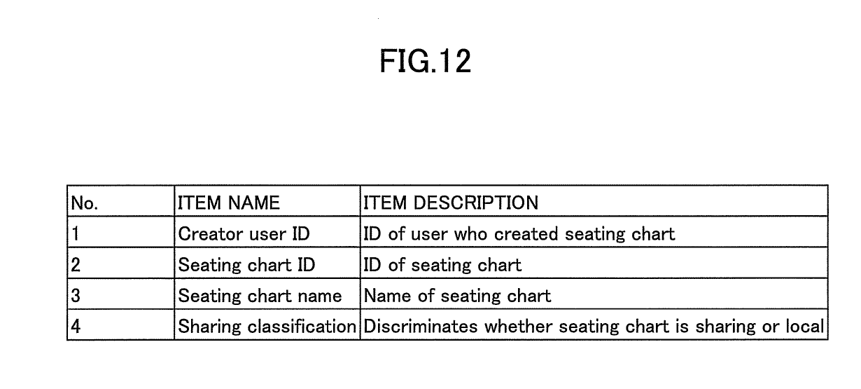

The newly registered seating chart has a seating chart property having a data structure illustrated in FIG. 12, for example. FIG. 12 is a diagram illustrating an example of the data structure of the seating chart property. The inputs made from the seating chart create screen 100 may be reflected to the seating chart name and the value of a sharing classification in the seating chart property, while the values of a user ID of the creator of the seating chart and a seating chart ID in the seating chart property may be input automatically.

(Example Operation of Creating Seat)

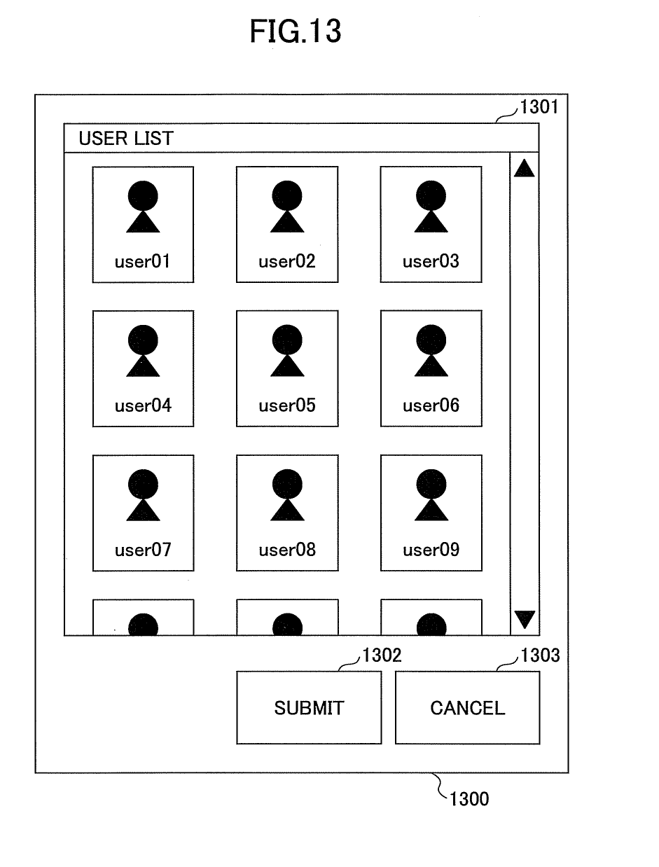

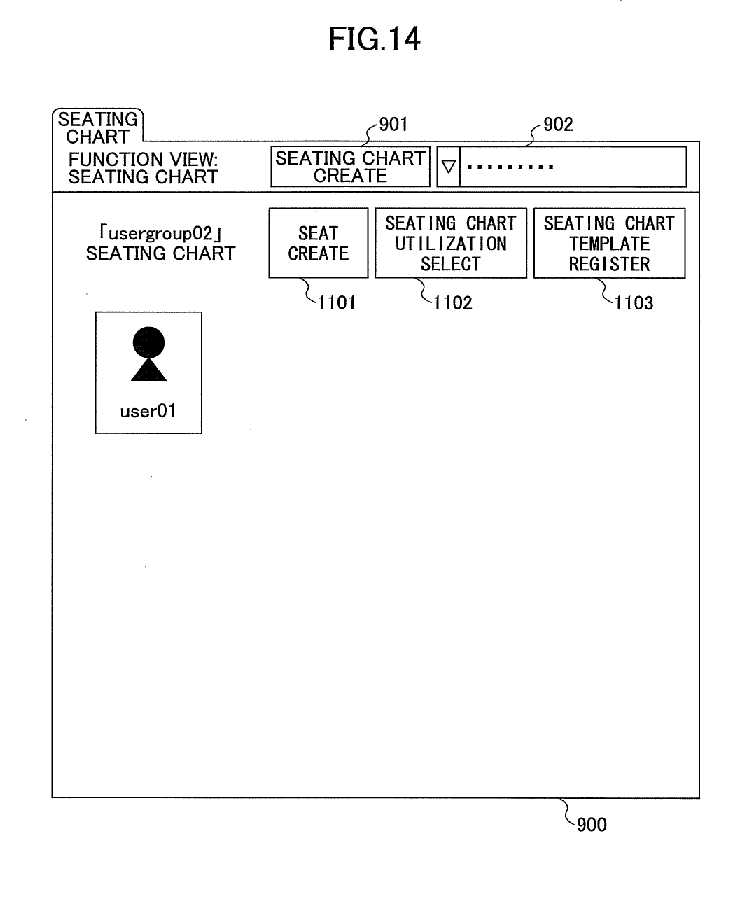

FIG. 13 is a diagram illustrating an example of a seat create screen. When creating the set of the user in the seating chart, the user may perform a left-click operation using the mouse 26, for example, with respect to a seat create button 1101 on the seating chart window 900 illustrated in FIG. 11. As a result, a seat create screen 1300 illustrated in FIG. 13 is displayed. The user may perform a click operation using the left button of the mouse 26, for example, in order to select a user (for example, user01) to be arranged in the seating chart from a user list 1301. When a submit button 1302 is selected after selecting the user, the seat create screen 1300 is closed, and a new seat (for example, user01) is created and displayed within the seating chart window 900 as illustrated in FIG. 14. FIG. 14 is a diagram illustrating the example of the seating chart window. On the other hand, when a cancel button 1303 is selected, the seat create screen 1300 is closed, and the seat create operation is cancelled.

The seat create operation may be performed using the seating chart display function of the display component 501, and a seat create function and a seat display function of the seating chart component 514 in the function component structure illustrated in FIG. 5. Hence, seat position information and member set data of the seat component 515 are set, and finally, the seat position information of the new seat and the member set data are registered in the DB of the storage part 101 using the add function of the DB access component 504.

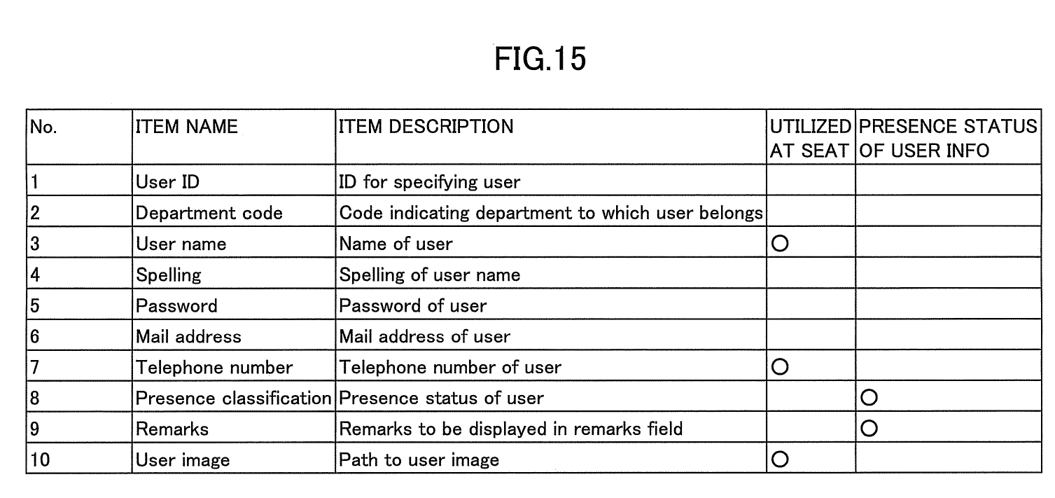

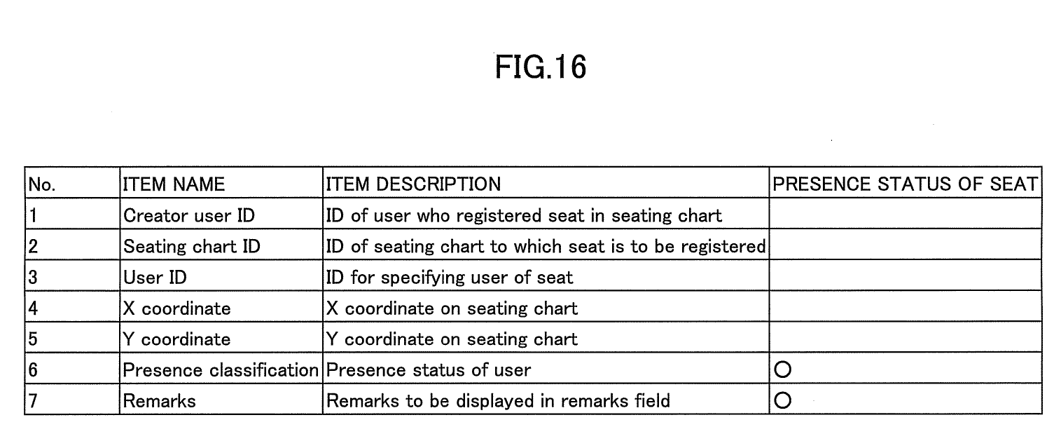

Each user within the user list 1301 separately holds attribute information thereof. FIG. 15 is a diagram illustrating an example of a data structure of user information. The user information includes data items and data values illustrated in FIG. 15. In addition, FIG. 16 is a diagram illustrating an example of a data structure of seating data. The newly registered seating data includes data items and data values illustrated in FIG. 16. The definition of each item and each item description is as illustrated in FIGS. 15 and 16. For example, the user ID within the seating data item corresponds to the user ID within the user information, and the seating data and the user information are related. Hence, the contents of the seat are displayed when the seat icon is clicked by the mouse 26 as will be described later, as a result of the user information being acquired using the user ID within the seating data as a key (or index). In other words, when displaying the contents of the seat, the user information (user name, spelling, telephone number, mail address, etc.) of the user who sits at the seat is displayed.

(Example Operation of Seat Content Display and Presence Status Setting)

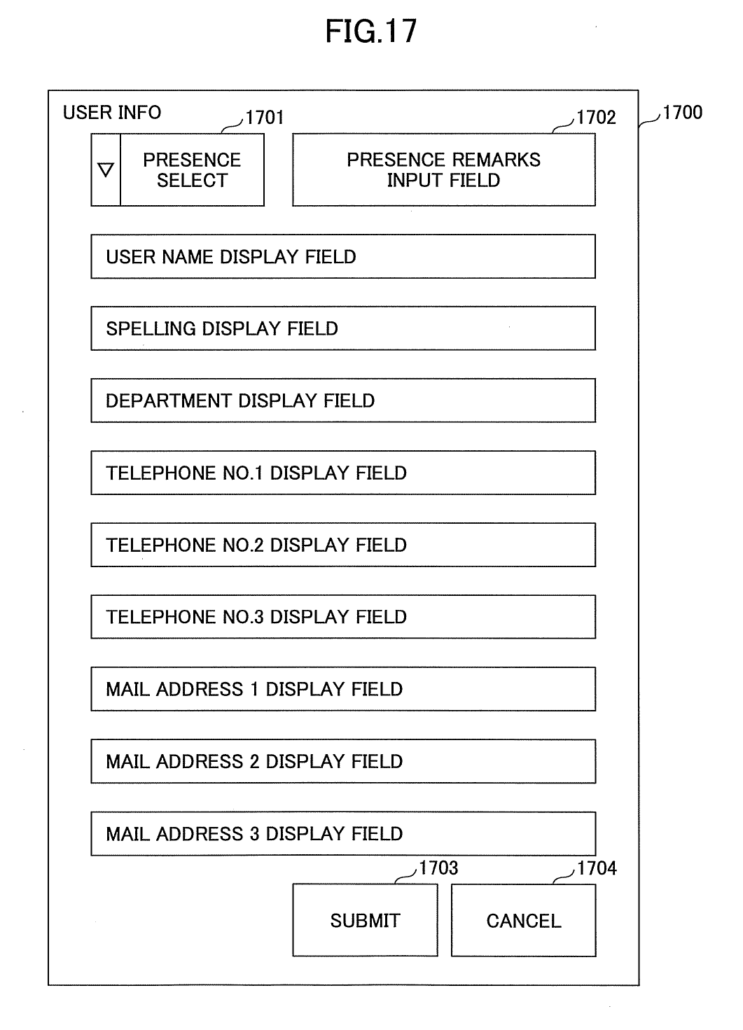

FIG. 17 is a diagram illustrating an example of a seating content display screen. When the user performs a double-left-click operation on the seating chart that is displayed in the seating chart window illustrated in FIG. 14 using the left button of the mouse 26, for example, a seat content display screen 1700 illustrated in FIG. 17 is displayed. The presence status and the user information of the user at the seat are displayed on the seat content display screen 1700. The seating data illustrated in FIG. 16 is reflected to the presence status of the user at the seat. The presence status may include information indicating the “present”, “not in seat”, “out”, “left office”, and “other” states of the user at the seat. The user information illustrated in FIG. 15 is reflected to the user information that is displayed. The user information that is displayed may include the user name and the attribute information thereof. For example, the user information that is displayed may include the user name, the spelling, the department (to which the user belongs), the telephone number (one or a plurality of telephone numbers), the mail address (one or a plurality of mail addresses), and the like. The presence status and the user information of the user at the seat may be confirmed by displaying the seat content display screen 1700.

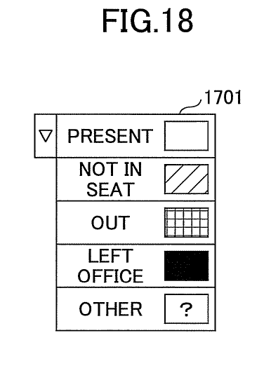

The presence status may be set by selecting a presence select box 1701 in the seat content display screen 1700. FIG. 18 is a diagram illustrating an example of a selection list of a presence selection. The presence status, such as the “present” “not in seat”, “out”, “left office”, and “other” states of the user at the seat may be selected from the presence select box 1701. The graphic pattern or color of each presence status may be displayed together with the seat in the seating chart depending on each presence status, in order to enable visual confirmation of the presence status. Of course, other arbitrary presence statuses may be provided, and the graphic pattern or color of such other arbitrary presence statuses may be set arbitrarily.

A presence remarks input field 1702 in the seat content display screen 1700 permits supplementary items related to the presence status to be freely input, if any. For example, if the presence status is “out”, the location where the user is visiting may be input to the present remarks input field 1702.

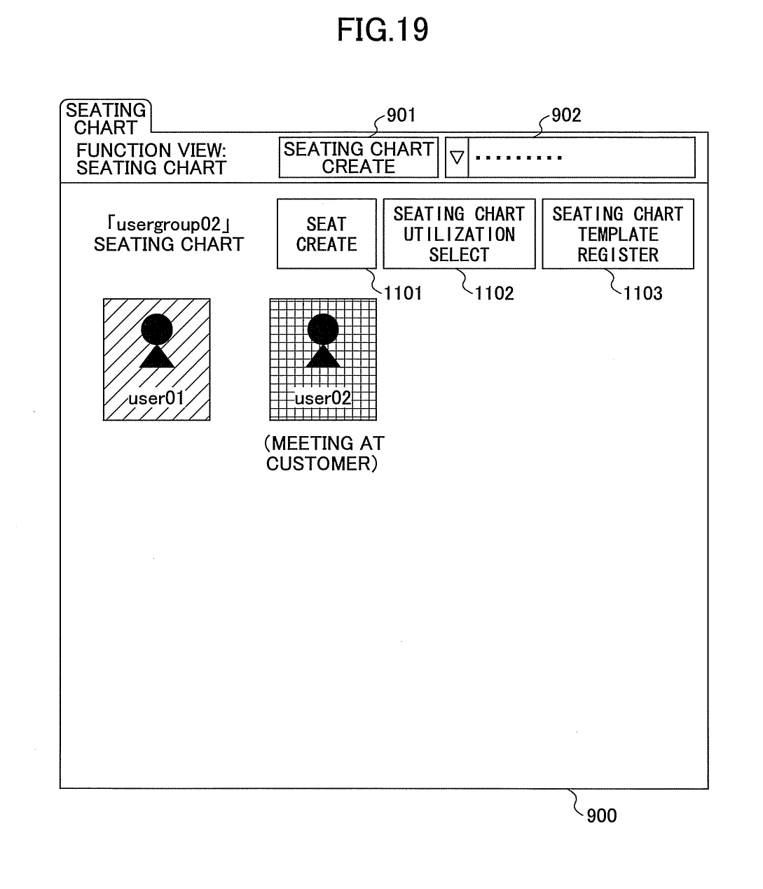

When the presence status setting or the like is made and a submit button 1703 in the seat content display screen 1700 is selected, the presence status setting or the like is reflected to the seat content display and the content display screen 1700 is closed, to thereby return the display to a screen in which the seating chart is displayed as illustrated in FIG. 19. On the other hand, when the presence status setting or the like is made and a cancel button 1704 in the seat content display screen 1700 is selected, the presence status setting or the like is cancelled and the content display screen 1700 is closed, to thereby return the display to a screen in which the seating chart is displayed as illustrated in FIG. 19.

FIG. 19 is a diagram illustrating the example of the seating chart window for a case where “not in seat” is set as the presence status. When the “not in seat” is selected from a selection list in the presence select box 1701, the graphic pattern (no coloring is added in this example) indicating “not in seat” is reflected to the seat icon for “user01” that is displayed. In the seating chart window 900 illustrated in FIG. 19, it is assumed for the sake of convenience that the seat icon for “user02” is created and the presence status thereof is set to “out”. In this example, “meeting at customer” is input to the presence remarks input field 1702 in the seat content display screen 1700 illustrated in FIG. 17.

In the data structure of the user information illustrated in FIG. 15 and the data structure of the seating data illustrated in FIG. 16, the data item having the item name “presence classification” is provided for the following reasons. That is, the data item having the item name “presence classification” holds the value indicating the presence status of the user, but the value of the presence status to be reflected to the corresponding seat icon in the seating chart may be that of the user information or the seating data depending on the presence status. As a rule, the value of the “presence classification” within the seating data may be set as the presence status and reflected to the graphic pattern of the corresponding seat icon, regardless of whether the presence status is “present”, “not in seat”, “out”, “left office”, or “other”. On the other hand, it may be more convenient to set the value of the “presence classification” within the user information as the presence status and to reflect this value to the graphic pattern of the corresponding seat icon, if the presence status is “out” or “left office”.

For example, suppose that the user has his seat in each of two or more offices. In this case, if the user is seated at a seat “a” in a first office, the presence status at the seat “a” in a seating chart A is “present”, while the presence status of this user may be “out” in a seat b in a seating chart B of a second office. In this case, the value of the “presence classification” within the seating data of each of the seats “a” and “b” is set as the presence status and reflected to the graphic pattern of the corresponding seat icon, with respect to the first and second offices.

On the other hand, if the user is out visiting a customer or has left the office by taking a holiday, for example, the presence status should be the same in both the first and second offices. In other words, the presence status of the seats “a” and “b” should both be “out” or “left office”. Hence, when the presence status is the same and is “out” or “left office”, for example, it may be more convenient to set the value of the “presence classification” within the user information, not the seating data, as the presence status for each of the seats “a” and “b” and to reflect this value to the graphic pattern of the seat icon, if the presence status is “out” or “left office”.

Further, if the user leaves the office, the presence status of the seat “a” in the first office may be changed to “left office”. As a result, the value of the “presence classification” within the user information is changed to “left office”. In this case, the value of the “presence classification” within the user information is also set as the presence status for the seat “b”, and this value is reflected to the graphic pattern of the corresponding seat icon. As a result, the presence status of the seat “b” is automatically changed to “left office” without having to change the presence status of the seat “b”.

The seat content display operation described above may be performed using the seating chart display function of the display component 501, the seat display function of the seating chart component 514, and a content display function of the seat component 515, in the function component structure illustrated in FIG. 5. In addition, the seat content update operation for the case where the presence status or the like is set (or updated) may be performed by the seating chart display function of the display component 501, a presence display function and a presence set function of the seat component 515, and finally, the presence information of the seat in the DE of the storage part 101 may be updated by the update function of the DB access component 504.

(Example Operation of Moving Seat)

When moving the seat in the seating chart, the user may perform a drag-and-drop operation using the mouse 26 by dragging and moving the seat icon of “user01” in the seating chart screen illustrated in FIG. 14, for example, and dropping the seat icon at a position of an arbitrary move destination for the seat in the seating chart. This seat move operation may be performed when modifying the seating arrangement or layout of the seats in the seating chart, for example.

The seat move operation may be performed using the seating chart display function of the display component 501, the seat display function and the seat paste function of the seating chart component 514, and a move function of the seat component 515, in the function component structure illustrated in FIG. 5. Hence, the seat position information of the seat component 515 is changed and set, and finally, the seat position information in the DB of the storage part 101 is updated by the update function of the DB access component 504.

(Example Operation of Deleting Seat)

When deleting the seat in the seating chart, the user may perform a right-click operation using the mouse 26, for example, with respect to the seat icon of “user01” in the seating chart screen illustrated in FIG. 14. In this case, a menu box is displayed, and this menu box enables the user to select a delete operation instruction with respect to the seat. The user may delete the seat by selecting “delete” within the menu box. As a result, the seat that is displayed up to that point in time is deleted and is no longer displayed thereafter.

The seat delete operation may be performed using the seating chart display function of the display component 501, the seat display function of the seating chart component 514, and a process select function of the seat component 515, in the function component structure illustrated in FIG. 5. Thus, the seat position information and the member set data of the seat component 515 are deleted, and finally, the seat information in the DB of the storage part 101 is deleted by the delete function of DB access component 504.

(Example Operation of Utilizing Sharing Seating Chart)

In the seating chart illustrated in FIG. 11, a seating chart utilization select button 1102 is provided. When the user wishes to utilize the sharing seating chart, the user performs a left-click operation using the mouse 26, for example, in order to select the seating chart utilization select button 1102. As a result, a seating chart utilization select screen 2000 illustrated in FIG. 20 is displayed. FIG. 20 is a diagram illustrating an example of the seating chart utilization selection screen. The seating chart utilization select screen 2000 includes two seating charts 2001 and 2002 that are registered and displayed. The seating chart 2002 may be a sharing seating chart.

When utilizing the seating chart 202 as a sharing seating chart, the user performs a left-click operation on a sharing button 2003 using the mouse 26, for example. Hence, the seating chart utilization select screen 200 is closed, and a sharing seating chart (for example, seating chart name “usergroup02”) to be utilized by sharing is added to the selected item within the selection box illustrated in FIG. 9. The sharing seating chart may not be edited by a user other than the creator (for example, “user01). When the creator modifies the sharing seating chart, the seating chart of each user is automatically updated. The seating chart added within the selection box 902 in FIG. 9 is displayed within the seating chart window 900 if selected from the selection box 902.

The shared utilization operation of the sharing seating chart may be performed using the seating chart display function of the display component 501, a seating chart utilization set function and a seating chart property set function of the seating chart component 514, in the function component structure illustrated in FIG. 5. By setting the shared utilization of the sharing seating chart, the seating chart property (“sharing classification”: sharing) of the seating chart component 514 is newly created, and finally, the sharing seating chart set to the shared utilization by the user is registered in the DB of the storage part 101 by the add function of the DB access component 504.

On the other hand, when utilizing the sharing seating chart 202 individually (that is, by non-sharing), the user performs a left-click operation on an individual utilization button 2004 using the mouse 26, for example. Hence, the seating chart utilization select screen 200 is closed, and the sharing seating chart (for example, seating chart name “usergroup02”) to be utilized individually is added to the selected item within the selection box illustrated in FIG. 9. The sharing seating chart that is set for the individual utilization becomes a new local seating chart that may be edited by a user other than the creator (for example, “user01) of the sharing seating chart.

The individual utilization operation of the sharing seating chart may be performed using the seating chart display function of the display component 501, the seating chart utilization set function and the seating chart property set function of the seating chart component 514, in the function component structure illustrated in FIG. 5. By setting the individual utilization of the sharing seating chart, the seating chart property (“sharing classification”: non-sharing) of the seating chart component 514 is newly created, and finally, the sharing seating chart set to the individual utilization by the user is registered in the DB of the storage part 101 by the add function of the DB access component 504.

(Example Operation of Pattern Registration of Local Seating Chart)

In the seating chart illustrated in FIG. 11, a seating chart template register button 1103 is provided. When the user wishes to register the template of the local seating chart, the user performs a left-click operation on the seating chart pattern register button 1103 using the mouse 26, for example. In this case, a dialog box (yes/no) is displayed to urge the user to confirm whether the seating chart that is presently displayed is to be registered as a template. When the user selects “yes” in the dialog box, a template registration process is performed to register the seating chart that is presently displayed as the template. On the other hand, when the user selects “no” in the dialog box, the template registration process to register the seating chart that is presently displayed as the template is cancelled.

The template registration process may be performed by the seating chart display function of the display component 501, a seating chart open function of the seating chart component 514, in the function component structure illustrated in FIG. 5. By registering the seating chart as the template, the seating chart property of the seating chart component 514 is newly created as a template, and the local seating chart is registered as the template in the DB of the storage part 101 by the add function of the DB access component 504. The seating chart is laid open or, made known, by the seating chart open function of the seating chart component 514.

When the user selects “yes” in the dialog box, the local seating chart that is registered as the template is displayed in the seating chart utilization select screen illustrated in FIG. 20. In the example illustrated in FIG. 20, the seating chart 2001 is displayed as the local seating chart that is registered as the template.

When individually utilizing the template of the local seating chart 2001, the user may perform a left-click operation on the local seating chart 2001 and then on the individual utilization button 2004 using the mouse 26, for example. In this case, the seating chart utilization select screen 2000 is closed, and the individually utilized local seating chart (for example, “seating chart name”: project A) is added to the selected item within the selection box 902 illustrated in FIG. 9. By setting the template for individual utilization, the newly created local seating chart may be edited by a user other than the creator (for example, “user01”) of the original template.

The create operation to create the local seating chart set for the individual utilization may be performed using the seating chart display function of the display component 501, and the seating chart utilization set function and the seating chart property set function of the seating chart component 514, in the function component structure illustrated in FIG. 5. By setting the local seating chart to be registered as the template for the individual utilization, the seating chart property of the seating chart component 514 is newly created, and finally, the local seating chart set for the individual use is registered in the DB of the storage part 101 by the add function of the DB access component 504.

(Example Operation of Tag Transmission Utilizing Seating Chart)

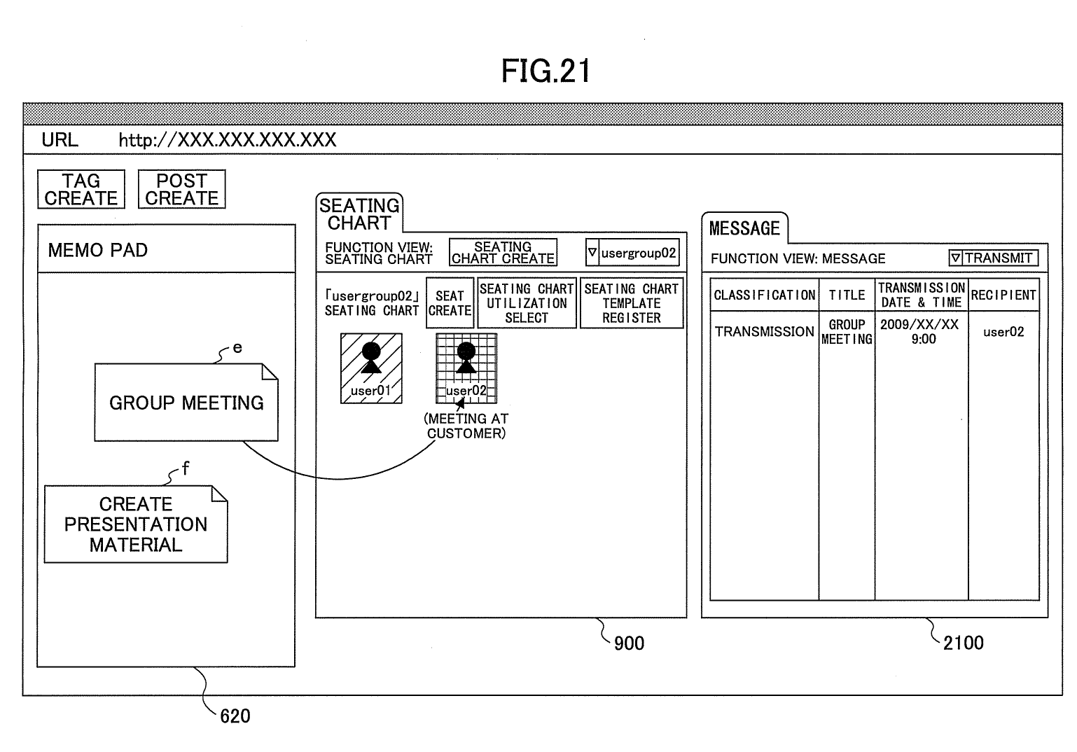

FIG. 21 is a diagram illustrating an example of the basic screen of the groupware for explaining a tag transmitting operation utilizing the seating chart. The basic screen illustrated in FIG. 21 includes a memo pad window 620, a seating chart window 900, and a message window 2100 that are displayed in a multi-window format.

The tags “e” and “f” are arranged in the memo pad window 620, and as described above, the tags “e” and “f” may be moved or copied onto the various function views. The tag “e” is created by the tag create screen 700 illustrated in FIG. 7. It is assumed for the sake of convenience that “group meeting” is input to the title input field 701 and “to create specification. meeting room 2. reserved” is input to the content input field 702 of the tag create screen 700. Accordingly, the tag “e” holds values “group meeting”, “to create specification. meeting room 2. reserved” in the items “title” (No. 4) and the “contents” (No. 5) in the tag data structure illustrated in FIG. 8A, respectively.

When transmitting (or sending) the “tag” using the seating chart, the user displays the seating chart that includes a destination party to whom the tag is to be sent, from the selected item within the selection box 902 illustrated in FIG. 9. In this example, it is assumed for the sake of convenience that the tag “e” is to be sent to the user “user02” within the seating chart “usergroup02”.

In this case where the transmitting destination is the user “user02”, the tag “e” on the memo pad window 620 is moved by a drag operation using the mouse 26 and dropped on the seat of the user “user02” within the seating chart window 900 by a drop operation using the mouse 26, for example. When the tag “e” is dropped, the tag “e” disappears from the display, but the tag “e” is transmitted to the user “user02” as a message. The transmitted tag “e” may be confirmed on the function view “message” (or message view) at the user “user02”.

The function view “message” is one of the function views that enables the message to be exchanged. In the message window 2100 illustrated in FIG. 21, the classification “transmission”, the title “group meeting”, the transmission date and time “2009/xx/xx”, and the recipient “user02” are added and displayed in the transmit list of the function view “message” of the user “user01” who transmitted the tag “e” as the message to the user “user02”, at the timing when the tag “e” is transmitted. The classification of the message to be displayed in the selection box at the upper right of the message window 2100 may be selected from “transmit”, “receive” and “all”, for example. In the message window 2100 illustrated in FIG. 21, the classification “transmit” is selected in the selection box, and the message that has been transmitted is displayed as a transmission log.

The tag transmitting operation may be performed using the seating chart display function and the message display function of the display function 501, the seat display function and a message transmitting function of the seating chart component 514, and a transmitting message display function of the message component 515, in the function component structure illustrated in FIG. 5. The tag data at the transmitting end (user01) is updated at the timing when the tag is dropped on the seat. More particularly, the item No. 6 (arranging destination: memo pad→message), the item No. 21 (update date), and the item No. 22 (update person: user01) in the data items illustrated in FIGS. 8A and 8B are updated. On the other hand, the item No. 25 (recipient) is newly set to the transmitting destination user “user02”, and the item No. 26 (received date and time) is newly set to the date and time when the transmission is made. Hence, the tag data at the transmitting end is updated in the DB of the storage part 101 using the update function of the DB access component 504.

In addition, the tag at the receiving end may be newly created. In the tag data at the receiving end (user02), item No. 1 is automatically generated and assigned, item No. 2 is set to the transmitting user ID “user02”, item Nos. 4 and 5 are copied from the tag data at the transmitting end, item No. 6 is set to the function view “message”, item Nos. 19 and 24 are set to the date when the tag is transmitted, and item Nos. 20 and 23 are set to the user, in the data items illustrated in FIGS. 8A and 8B. The tag data at the receiving end is added to the DB of the storage part 101 using the add function of the DB access component 504.

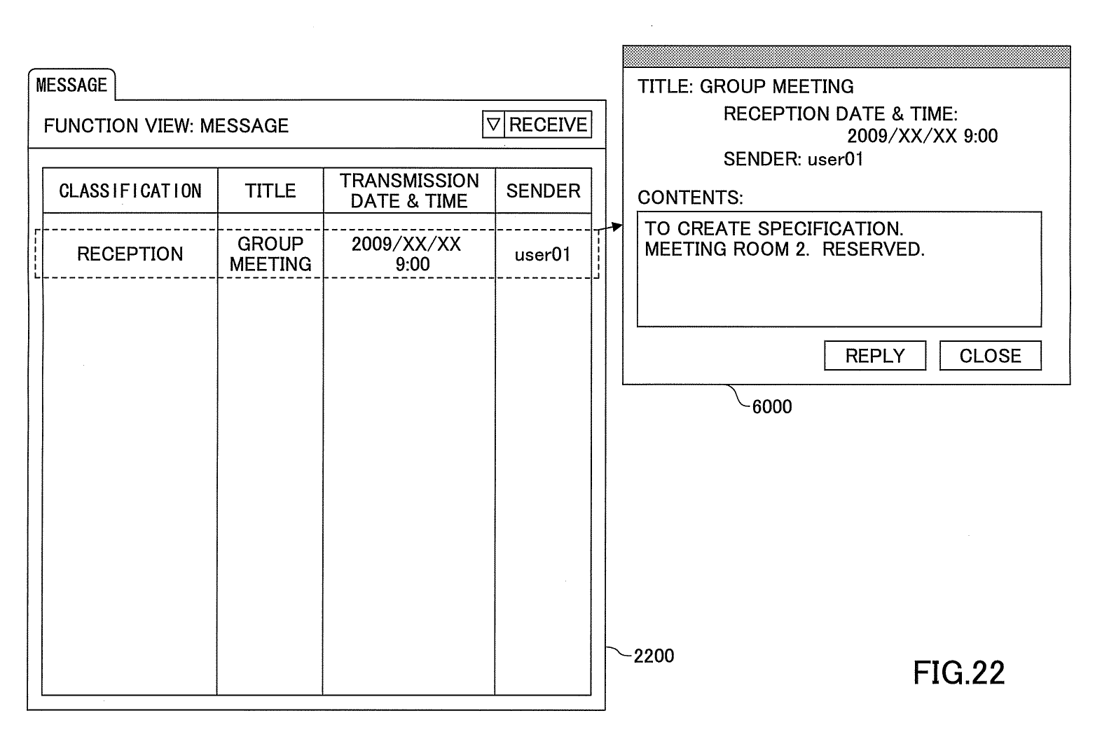

On the other hand, the received message may be confirmed by displaying the function view “message” from the groupware at the receiving end user “user02”. FIG. 22 is a diagram illustrating an example of the message window. A message window 2200 illustrated in FIG. 22 displays the message transmitted from the transmitting end (user01) on the list of messages at the receiving end (user02). In this example, the displayed message includes the classification “reception”, the title “group meeting”, the reception date and time “2009/xx/xx”, and the sender “user01”. When the user performs a double-left-click on this displayed message using the mouse 26, for example, a message content confirmation screen 6000 indicated on the upper right of FIG. 22 is displayed to enable the user to confirm the contents of the message at the receiving end. As illustrated in FIG. 22, the message content confirmation screen 6000 includes the title “group meeting”, the content “to create specification. meeting room 2. reserved”, and the like which may be confirmed by the user at the receiving end. The contents displayed in the message content confirmation screen 6000 matches the data contents held by the tag “e”. A reply may be made with respect to the received message by selecting a reply button on the message content confirmation screen 6000.

A display operation to display the received message may be performed by the message display function of the display component 501, a received message display function of the message component 516, and the content display function of the tag component 502, in the function component structure illustrated in FIG. 5.

(Example Operation of Tag Transmission Utilizing Post Set with Transmitting Destination)

When transmitting the tag in the above described case, the tag is moved by dragging the tag and dropping the tag on the seating chart, for example, in order to transmit the tag as a message. A description will now be given of an example that similarly transmits the tag as a message, but using the post concept.

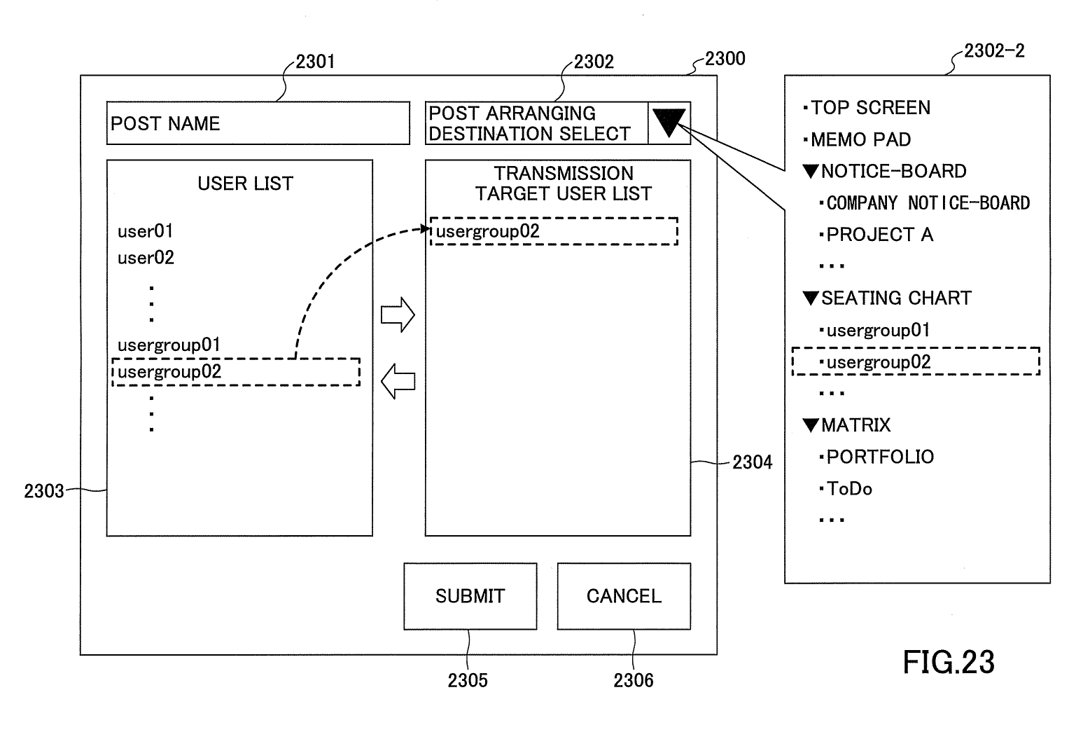

When creating the post, the user performs a left-click operation on the post create button 650 illustrated in FIG. 6 using the mouse 26, for example. In this case, a post creating or editing screen 2300 illustrated in FIG. 23 is displayed. FIG. 23 is a diagram illustrating an example of the post creating or editing screen. The user inputs an arbitrary post name to be created into a post name field 2301 on the post creating or editing screen 2300, and performs a left-click on a post arranging destination select field 2302 using the mouse 26, for example, in order to display a post arranging destination selection list 2302-2. The post arranging destination may be selected not only from the seating chart, but also from any of the top screen or the function views “memo pad”, “notice-board”, “matrix” and the like. In this example, it is assumed for the sake of convenience that the post arranging destination is set to the top screen, and thus, the top screen is selected from the post arranging destination selection list 2302-2.

Next, the transmitting target user is set according to the following procedure. First, the transmitting target user is selected from a user list 2303 in the post creating or editing screen 2300, and a drag-and-drop operation is performed to a transmitting target user list 2304 using the mouse 26, for example. This operation is repeated until the setting of the transmitting target user ends. The individual users (user01, user02, etc.) and the seating chart (usergroup01, usergroup02, etc.) representing the user groups are also, registered in the user list 2303. Thus, the transmitting target user may be set in units of the individual or units of group members. In this example, the seating chart “usergroup02” is set as the transmitting target user.

After the setting of the transmitting target user is completed, a submit button 2305 is selected to close the post creating or editing screen 2300. As a result, a graphic image of the post is created and displayed on the top screen. On the other hand, if a cancel button 2306 is selected after setting of the transmitting target user is completed, the creating of the post is cancelled.

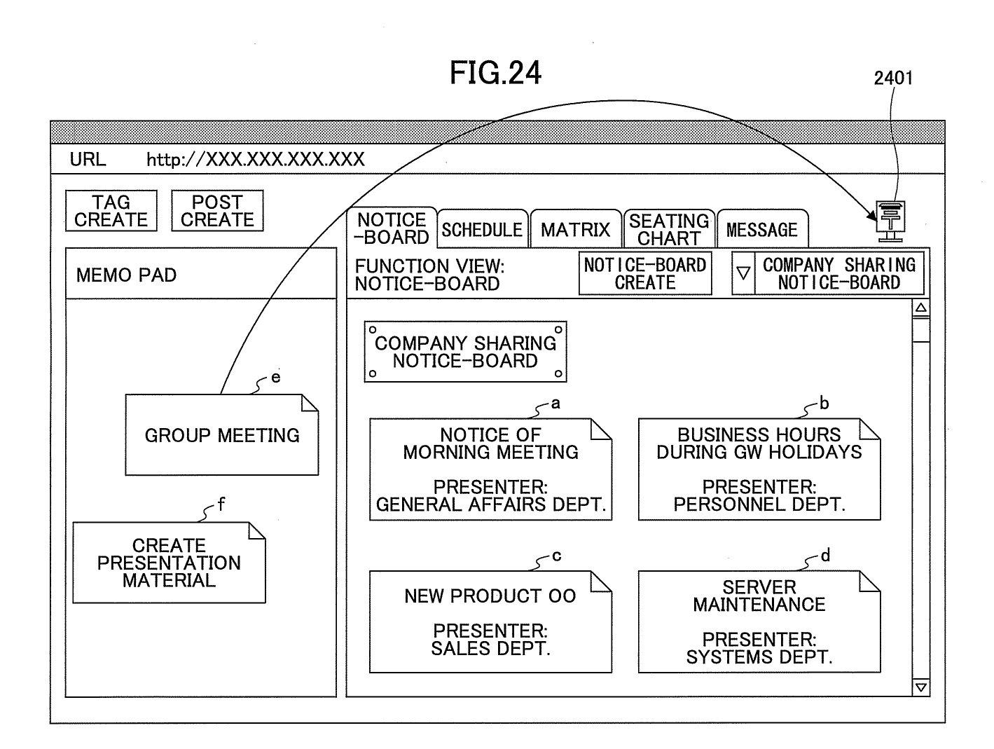

FIG. 24 is a diagram illustrating an example of the display of the post arranged on the top screen. As illustrated in FIG. 24, a post 2401 is created and arranged on the top screen. By performing a drag-and-drop operation to drag the tag and drop the tag on the post 2401 using the mouse 26, for example, the tag is transmitted, as the message, to the transmitting target user that is set, as will be described later.

The post create operation may be performed using a post create instruction function and a post display function of the display component 501, and a transmitting target set function of the post component 505, in the function component structure illustrated in FIG. 5. Hence, the post property of the post component 505 is set, and finally, the property of the newly created post is added to the DB of the storage part 101 using the add function of the DB access component 504.

Next, the tag is transmitted using the post set with the transmitting destination. When transmitting the tag “e”, the user performs a drag operation to move the tag “e” to the post 2401 and to drop the tag “e” on the post 2401 in FIG. 24 using the mouse 26, for example. In this case, the tag “e” is transmitted as the message with respect to all transmitting destination users set with respect to the post 2401. More particularly, since the seating chart “usergroup02” is set as the transmitting target user, the tag “e” is transmitted as the message with respect to all users having a seat in the seating chart “usergroup02”. In other words, a single drag-and-drop operation to the post 2401 realizes the same operation as repeating the drag-and-drop operation with respect to the tag “e” for the seats of all transmitting target users in the seating chart “usergroup02”. Hence, by using the post 2401 to transmit the tag “e”, the tag “e” may be simultaneously transmitted to each of the transmitting target users in one operation, and the operation may be simplified compared to the case where the operation of transmitting the tag “e” to the transmitting target user is repeated for each of the transmitting target users. In addition, the transmitted tag “e” may be confirmed on the function view “message” at the transmitting target user.

In the above described example, the post name is input, the post arranging destination is selected, and the transmitting target user is set on the post creating or editing screen 2300. However, in a modification related to the setting of the transmitting target user, only the post name input and the selection of the post arranging destination may be made on the post creating or editing screen, and the setting of the transmitting target user may not be made. When transmitting the tag using the post, the screen of the user list 2303 and the transmitting target user list 2304, similar to the post creating or editing screen 2300, may be displayed at a stage when the drag-and-drop operation is performed on the tag with respect to the post, in order to urge the user to set or specify the transmitting target user. Compared to transmitting the tag to the preset transmitting target users using the post set with the transmitting destination, this modification may flexibly set the transmitting destination by setting the transmitting destination user each time the tag is to be transmitted. Moreover, even with respect to the post that is set with the transmitting destination, the post creating or editing screen 2300 may be displayed at a stage when the drag-and-drop operation is performed on the tag with respect to the post, in order to enable additional transmitting target users to be further set or specified.

### Example 3

### Interaction of Message and Each Function View

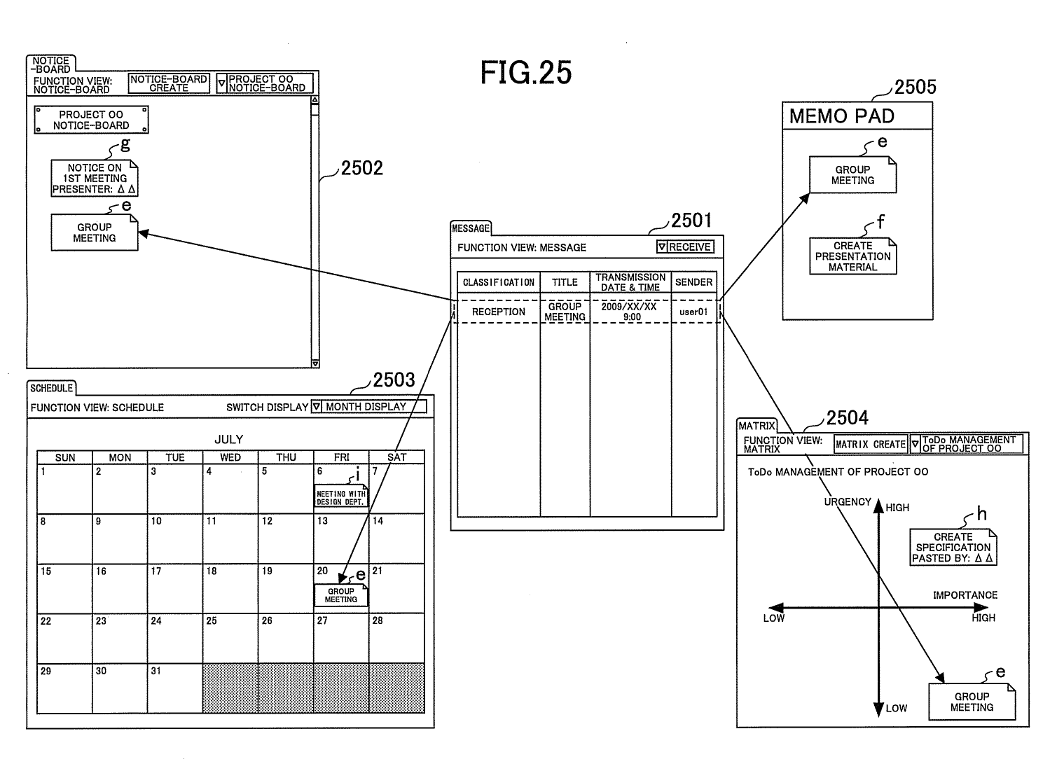

FIG. 25 is a diagram for explaining the interaction between the message (view) and other function views. FIG. 25 illustrates a message window 2501, a notice-board window 2502, a schedule window 2503, a matrix window 2504, and a memo pad window 2505.

The notice-board window 2502 provides a function view to present the tag and share the status. The schedule window 503 provides a function view to perform a schedule management of the individual or group member in the schedule chart. The matrix window 2504 provides a function view to perform a task management of task importance or the like. The memo pad window 2505 provides a temporary work field to temporality hold or save the tag.

As described above, in the groupware system 100 of this embodiment, the server apparatus 1 forming the groupware server provides the various groupware functions to the client terminals 2. In addition, the groupware enables the use of the memo pad and the function views of the notice-board, the schedule, the matrix and the like illustrated in FIG. 6, in addition to the function views of the seating chart and the message.

In the message window 2501 illustrated in FIG. 25, the tag “e” that is transmitted via the seating chart is arranged in the form of the message. Hence, when the drag-and-drop operation is performed to drag and drop the message onto the memo pad or the various function views in the message window 2501 as illustrated in FIG. 25, the message may be arranged again in the memo pad or each of the function views as the tag “e”, as will be described hereunder.

In this example, the message corresponding to the tag “e” includes the value “group meeting” for the title (item No. 4 in FIG. 8A), and the value “to create specification. meeting room 2. reserved” for the contents (item No. 5 in FIG. 8A). If the information contained in this message is to be made known, the message may be presented as the tag on the notice-board. When the message corresponding to the tag “e” is dragged and dropped on the notice-board window 2502 in the message window 2501 by a drag-and-drop operation, the message may again be arranged in the notice-board window 2502 as the tag “e”. With respect to the data attached to the tag “e”, the data held within the message window 2501 is inherited and stored as it is, but the data values of the item No. 13 (presenter) and the item No. 14 (notice expiry) in FIG. 8A are essential when the tag “e” is arranged in the notice-board 2502. Hence, the data value of the item No. 13 (presenter) may be automatically input when the drop operation is performed. On the other hand, a predetermined time period may be automatically input as the data value of the item No. 14 (notice expiry) or, a dialog may be displayed to urge input of the notice expiry at a timing when the drop operation is performed. In order to make the information contained in this message more known, for example, the tag “e” may be transmitted as the message with respect to the use of the notice-board when the tag “e” is arranged in the notice-board window 2502. Of course, the recipient of the message may confirm the message utilizing the message window 2501.

In addition, the content of the message corresponding to the tag “e” in this example indicates that the group meeting will be held. Hence, it may be useful to the schedule management if the group meeting is scheduled in the schedule window 2503. In this case, the message corresponding to the tag “e” may again be arranged in the schedule window 2503 as the tag “e” by performing a drag-and-drop operation, similar to that described above, to drag and drop the message on the schedule window 2503 in the message window 2501.

Moreover, because the content of the message corresponding to the tag “e” in this example indicates that the group meeting will be held, it may be useful to the task management if the group meeting is registered as a task in the matrix window 2504. In this case, the message corresponding to the tag “e” may again be arranged in the matrix window 2504 as the tag “e” by performing a drag-and-drop operation, similar to that described above, to drag and drop the message at a predetermined position on the matrix window 2504 in the message window 2501, by taking into account an urgency or an importance of the message.

The message corresponding to the tag “e” may again be arranged in the memo pad window 2505 as the tag “e” by performing a drag-and-drop operation, similar to that described above, to drag and drop the message on the memo pad window 2505 in the message window 2501, if the content of the message indicating that the group meeting will be held is to be temporarily held or saved.

In general, each function view has its original role, and the information required of the function view differs for each function view. Hence, when the tag is arranged in the function view, the data attached to the tag differs for each function view. However, as may be seen from the data structure of the tag illustrated in FIGS. 8A and 8B, the tag in the embodiment has the data structure that enables all data that may be used in any of the memo pad and each of the function views. As a result, all data of the tag may be stored regardless of the memo pad or each of the function views in which the tag is arranged. Consequently, the various information utilized in each function view may be utilized in a seamless manner, for each of the function views. In other words, by performing a cut-and-paste-like operation on the tag between two of the memo pad and the function views, the various information utilized by each function of the groupware may be managed to provide a seamless interaction or link of the functions, in order to realize efficient information sharing and consistent operation.

### Example 4

### Interaction of Seating Chart and Schedule

Next, a description will be given of an example of an operation in which a planned action category set in the tag that is pasted to the function view “schedule” is automatically reflected to the user information and the presence status of the seating data.

As may be seen from FIGS. 8A and 8B, the data items “planned action category” (item No. 3), “planned start date” (item No. 17), and “planned end date” (item No. 18) are essential values in the data structure of the function view “schedule”. In other words, when the tag is arranged in the function view “schedule”, the values indicating the “planned action category”, “planned start date” and “planned end date” are held or saved.

The “planned start date” and the “planned end date” indicate a planned start date and a planned end date of a schedule, and each hold information indicating the specific year, month and date. The “planned action category” indicates a category of the presence status depending on the schedule. For example, when the schedule is to be performed, the planned action is categorized into “planned action category: 2” if the presence status is “not in seat”, “planned action category: 3” if the presence status is “out”, and “planned action category: 4” if the presence status is “left office”.

More particularly, when there is a scheduled meeting, the data attached to the tag arranged in the function view “schedule” may include “planned action category: 2”, “planned start date: 2009/xx/xx”, and “planned end date: 2009/yy/yy”, for example. In accordance with this scheduled meeting, the presence status of the user should be “not in seat” during the scheduled meeting. In addition, if the user has plans to go out of the office, the data attached to the tag arranged in the function view “schedule” may include “planned action category: 3”, “planned start date: 2009/xx/xx”, and “planned end date: 2009/yy/yy”, for example. In accordance with this schedule to go out, the presence status of the user should be “out”.

Accordingly, this embodiment may automatically reflect the planned action category set in the tag that is pasted to the function view “schedule” to the user information and the presence status of the seating data, and update the user information and the presence status of the seating data, by the interaction (or linking) of the function view “schedule” and the function view “seating chart”. Hence, it is unnecessary for the user to manually set the presence status (for example, present, not in seat, out, etc.) on the selection list in the presence select box 1701 illustrated in FIG. 18, thereby eliminating the consequences of the user forgetting to set the presence status of the seating data.

In this case, when the tag is arranged in the function view “schedule” and the “arranging destination” (item No. 6) in FIG. 8A is set in the data attached to the tag, the checker component 507 monitors the values of the “planned action category” and the “planned start date”, and sets the value of the “presence classification” in the seating data of the user in FIG. 16 to “not in seat” on the planned start date. In addition, the checker component 507 monitors the value of the “planned end date” if necessary, and may set the presence status of the seating data of the user to “present” on the planned end date.

The presence status update operation may be performed using a monitor function and a presence status update function of the checker component 507, in the function component structure illustrated in FIG. 5. Hence, the presence information of the set in the DB of the storage part 101 is updated using the update function of the DB access component 504.

In both the data structure of the user information (or user data) illustrated in FIG. 15 and the data structure of the seating data illustrated in FIG. 16, the item name “presence classification” is provided in the data item, and this data item in each case holds a value indicating the presence status of the user. However, the updating result using the presence status indicated by the data item “presence classification” of the user information is different from the updating using the presence status indicated by the data item “presence classification” of the seating data. As a rule, the value of the “presence classification” within the seating data may be set as the presence status and reflected to the graphic pattern of the corresponding seat icon, regardless of whether the presence status is “present”, “not in seat”, “out”, “left office”, or “other”, as described above. On the other hand, it may be more convenient to set the value of the “presence classification” within the user information as the presence status and to reflect this value to the graphic pattern of the corresponding seat icon, if the presence status is “out” or “left office”.

Hence, in a case where the data value is “planned action category: 3” (out) or “planned action category: 4” (left office) and the tag is arranged in the function view “schedule” (item No. 6) in FIG. 8A, for example, the checker component 507 may monitor the values of the “planned action category” and “planned start date”, and set the “presence classification” within the user information of the user in FIG. 15 to “out” or “left office” on the planned start date, instead of setting the “presence classification” within the seating data of the user in FIG. 16.

### SUMMARY

As described above in conjunction with the embodiment and examples, the tag may be moved or copied between the function views, including the memo pad, and interaction (or linking) of the tag data may be achieved. In addition, the tag (or image object) forms the information transfer medium to transfer the information processed by the groupware. Further, the tag data has the data structure that enables all data items to be stored, in order to enable free creation and arrangement of the tag on any of the function views and memo pad. Accordingly, in the groupware functions provided by the server apparatus (or groupware server), the interaction of the tag data may be achieved, and the user may treat various kinds of information in the same, consistent manner by performing the user-centered interactive operation in one of the memo pad and the function views or, by performing the user-centered interactive operation spanning two of the memo pad and the function views.

For example, the function view “seating chart” may provide a function to enable graphical and user-centered interactive management of the presence status of the user, and enable sending of the tag from one function view or the memo pad to the function view “message” to thereby realize a tag operation with respect to the set in the function view “seating chart”. Hence, the interaction of the tag data between the function views may be realized, and the user may perform the user-centered interactive operation to transfer the information.

Therefore, in one embodiment, the interaction of the various information may be achieved among the groupware functions, to provide a network system, a server apparatus, a groupware program, and a computer-readable storage medium that stores the groupware program, that may improve the operability by the user. As an example, the various information (for example, presence information, message, etc.) utilized by each function of the groupware may be managed to provide a seamless interaction or link of the functions, in order to realize efficient information sharing and consistent operation.

Because the tag data has the data structure that enables all data items to be stored, in order to enable free creation and arrangement of the tag on any of the function views and memo pad, the operation described above may be performed to move or copy the tag among various function views other than the function views and the memo pad described above.

Of course, although the examples are labeled first, second, etc. in the described embodiment, the ordinal numbers do not imply priorities of the examples.

Further, the present invention is not limited to these embodiments, but various variations and modifications may be made without departing from the scope of the present invention.

What is claimed is:

1. A network system comprising:
a server apparatus, including a first processor and a storage unit, configured to provide a plurality of groupware functions; and
a client terminal, communicatably coupled to the server apparatus, including a second processor and a display unit,
wherein the storage unit includes:
a first storage part configured to store first information related to a window in which a corresponding groupware function is realized, second information related to an image object to be displayed in an overlapping manner on the window, and data to be attached to the image object in correspondence with the window on which image object is to be displayed in the overlapping manner, so that all data attached to the image object are storable within data items in the first storage part regardless of any one of a plurality of windows on which the image object is displayed; and
a second storage part configured to store third information related to a seating chart window in which a corresponding groupware function is realized, fourth information related to a seat image to be displayed in an overlapping manner on the seating chart window, and user data to be attached to the seat image;
the first processor includes a transmitting part configured to transmit to the client terminal the first and second information and the data stored in the first storage part, and the third and fourth information and the user data stored in the second storage part;
the second processor includes:
a window display part configured to display a first window on the display unit based on the first information received from the server apparatus;
an image object display part configured to display the image object on the display unit in an overlapping manner on the first window based on the second information received from the server apparatus;
a seating chart window display part configured to display the seating chart window on the display unit based on the third information received from the server apparatus;
a seat image display part configured to display the set image on the display unit in an overlapping manner on the seating chart window based on the fourth information received from the server apparatus;
an operation part configured to move or copy the image object displayed on the first window to the seat image displayed on the seating chart window in response to a move or copy instruction; and
an update request part configured to make an update request for the data attached to the image object with respect to the server apparatus when the image object is moved or copied to the seat image by the operation part;
wherein the image object display part displays the moved or copied image object on the display unit in an overlapping manner on a second window that is specified by the user data attached to the seat image, together with the data attached to the image object, as message information; and
the first storage part of the server apparatus inherits and stores the data attached to the moved or copied image object, in correspondence with the user data attached to the seat image to which the image object is moved or copied and the second window, in response to the update request from the client terminal.

2. The network system as claimed in claim 1, wherein:
the transmitting part of the server apparatus further transmits to the client terminal fifth information related to a predetermined image, and user data to be attached to the predetermined image and related to at least one user or all users belonging within the seating chart;
the second processor of the client terminal further includes a predetermined image display part configured to display the predetermined image on the display unit in an overlapping manner on the first window or the seating chart window, based on the fourth information received from the server apparatus;
the operation part of the client terminal moves or copies the image object displayed in the overlapping manner on the first window to the predetermined image on the first window or the seating chart window;
the update request part of the client terminal makes the update request for the data attached to the image object with respect to the server apparatus when the image object is moved or copied to the predetermined image by the operation part;
the image object display part of the client terminal displays the moved or copied image object on the display unit in an overlapping manner on the second window that is specified by the user data attached to the predetermined image, together with the data attached to the image object, as message information; and
the first storage part of the server apparatus inherits and stores the data attached to the moved or copied image object, in correspondence with the user data attached to the predetermined image to which the image object is moved or copied and the second window, in response to the update request from the client terminal.

3. The network system as claimed in claim 1, wherein:
the transmitting part of the server apparatus further transmits to the client terminal fifth information related to a predetermined image;
the second processor of the client terminal further includes a predetermined image display part configured to display the predetermined image on the display unit in an overlapping manner on the first window or the seating chart window, based on the fourth information received from the server apparatus;
the operation part of the client terminal moves or copies the image object displayed in the overlapping manner on the first window to the predetermined image on the first window or the seating chart window, and receives input of user data to be attached to the predetermined image and related to at least one user or all users belonging within the seating chart;
the update request part of the client terminal makes the update request for the data attached to the image object with respect to the server apparatus when the image object is moved or copied to the predetermined image by the operation part;
the image object display part of the client terminal displays the moved or copied image object on the display unit in an overlapping manner on the second window that is specified by the user data attached to the predetermined image, together with the data attached to the image object, as message information; and
the first storage part of the server apparatus inherits and stores the data attached to the moved or copied image object, in correspondence with the user data attached to the predetermined image to which the image object is moved or copied and the second window, in response to the update request from the client terminal.

4. The network system as claimed in claim 1, wherein:
the operation part of the client terminal further moves or copies the image object displayed in the overlapping manner on the second window to a third window in which a groupware function related to one of a notice-board, a schedule, or a matrix is realized;
the update request part of the client terminal makes the update request for the data attached to the image object with respect to the server apparatus when the image object is moved or copied to the third window by the operation part;
the image object display part of the client terminal displays the moved or copied image object on the display unit in an overlapping manner on the third window, together with the data attached to the image object; and
the first storage part of the server apparatus inherits and stores the data attached to the moved or copied image object, in correspondence with the third window within the data items, in response to the update request from the client terminal.

5. The network system as claimed in claim 4, wherein:
in the client terminal, when the operation part moves or copies the image object displayed in the overlapping manner on the second window to the third window in which the groupware function related to the notice-board is realized, the display unit displays a predetermined image object for notifying update of the notice-board in an overlapping manner on the third window, as the message information, together with the data attached to the predetermined image data, with respect to each viewing target user of the notice-board; and
in the server apparatus, the first storage part inherits and stores the data attached to the moved or copied predetermined image object, in correspondence with the second window of each viewing target user within the data items, in response to the update request from the client terminal.

6. The network system as claimed in claim 1, wherein:
the user data attached to the seat image stored in the second storage part includes presence information of the user specified by the user data; and
the seat image display part of the client terminal reflects the presence information to the seat image before displaying the seat image on the display unit in the Overlapping manner on the seating chart window.

7. The network system as claimed in claim 6, wherein:
the data attached to the image object to be displayed in an overlapping manner on a schedule window that is related to a schedule includes time information indicating a start of the schedule, and planned action category information indicating a presence state at a time when the schedule is performed, when the first information stored in the first storage part is related to the schedule window that provides a schedule management function;
the planned action category information is reflected to the presence information of the user when the schedule is started based on the time information; and
the seat image display part of the client terminal reflects the planned action category information to the presence information of the user before displaying the presence information of the user on the display unit in an overlapping manner on the seating chart window.

8. The network system as claimed in claim wherein:
the storage unit of the server apparatus further includes a third storage part configured to store registered user data independent of the user data attached to the seat image stored in the second storage part;
the registered user data stored in the third storage part includes presence information of a user other than that of the user data attached to the seat image; and
the seat image display part of the client terminal reflects the presence information of the other user to the seat image before displaying the presence information of the other user on the display unit in an overlapping manner on the seating chart window.

9. The network system as claimed in claim 8, wherein:
the data attached to the image object to be displayed in an overlapping manner on a schedule window that is related to a schedule includes time information indicating a start of the schedule, and planned action category information indicating a presence state at a time when the schedule is performed, when the first information stored in the first storage part is related to the schedule window that provides a schedule management function;
the planned action category information is reflected to the presence information of the user when the schedule is started based on the time information; and
the seat image display part of the client terminal reflects the planned action category information to the presence information of the user before displaying the presence information of the user on the display unit in an overlapping manner on the seating chart window.

10. The network system as claimed in claim 1, wherein the seating chart window displayed on the display unit by the seating chart window display part of the client terminal includes a sharing seating chart window to be displayed and shared among a plurality of users, and local seating chart window to be displayed by one user.

11. The network system as claimed in claim 10, wherein the local seating chart window is laid open to a plurality of users, and edited by the user who acquires the local seating chart window that is laid open.

12. A server apparatus communicatable with at least one client terminal via a network, comprising:
a storage unit; and
a processor configured to provide a plurality of groupware functions,
wherein the storage unit includes:
a first storage part configured to store first information related to a window in which a corresponding groupware function is realized, second information related to an image object to be displayed in an overlapping manner on the window, and data to be attached to the image object in correspondence with the window on which image object is to be displayed in the overlapping manner, so that all data attached to the image object are storable within data items in the first storage part regardless of any one of a plurality of windows on which the image object is displayed; and
a second storage part configured to store third information related to a seating chart window in which a corresponding groupware function is realized, fourth information related to a seat image to be displayed in an overlapping manner on the seating chart window, and user data to be attached to the seat image;
the processor includes a transmitting part configured to transmit to the client terminal the first and second information and the data stored in the first storage part, and the third and fourth information and the user data stored in the second storage part; and
the first storage part inherits and stores data attached to an image object moved or copied at the client terminal, in correspondence with the user data attached to the seat image to which the image object is moved or copied and a second window that is specified by the user data attached to the seat image and displayed at the client terminal, in response to an update request from the client terminal.

13. The server apparatus as claimed in claim 12, wherein:
the transmitting part further transmits to the client terminal fifth information related to a predetermined image, and user data to be attached to the predetermined image and related to at least one user or all users belonging within the seating chart; and
the first storage part inherits and stores the data attached to the moved or copied image object, in correspondence with the user data attached to the predetermined image to which the image object is moved or copied and the second window, in response to the update request from the client terminal.

14. The server apparatus as claimed in claim 12, wherein:
the first storage part inherits and stores the data attached to a predetermined image object moved or copied at the client terminal, in correspondence with the second window of each viewing target user within the data items, in response to the update request from the client terminal.

15. The server apparatus as claimed in claim 12, wherein the user data attached to the seat image stored in the second storage part includes presence information of the user specified by the user data.

16. The server apparatus as claimed in claim 12, wherein:
the storage unit further includes a third storage part configured to store registered user data independent of the user data attached to the seat image stored in the second storage part; and
the registered user data stored in the third storage part includes presence information of a user other than that of the user data attached to the seat image.

17. A computer-readable storage medium which stores a groupware program which, when executed by a computer of a server apparatus, causes the computer to perform a process to provide a plurality of groupware functions to at least one client terminal via a network, the process comprising:
a first storage procedure causing the computer to store, in a first storage part of a storage unit, first information related to a window in which a corresponding groupware function is realized, second information related to an image object to be displayed in an overlapping manner on the window, and data to be attached to the image object in correspondence with the window on which image object is to be displayed in the overlapping manner, so that all data attached to the image object are storable within data items in the first storage part regardless of any one of a plurality of windows on which the image object is displayed;
a second storage procedure causing the computer to store, in a second storage part of the storage unit, third information related to a seating chart window in which a corresponding groupware function is realized, fourth information related to a seat image to be displayed in an overlapping manner on the seating chart window, and user data to be attached to the seat image; and
a transmitting procedure causing the computer to transmit to the client terminal the first and second information and the data stored in the first storage part, and the third and fourth information and the user data stored in the second storage part,
wherein the first storage procedure causes the computer to inherit and store data attached to an image object moved or copied at the client terminal, in correspondence with the user data attached to the seat image to which the image object is moved or copied and a second window that is specified by the user data attached to the seat image and displayed at the client terminal, in response to an update request from the client terminal.

18. The computer-readable storage medium as claimed in claim 17, wherein:
the transmitting procedure causes the computer to further transmit to the client terminal fifth information related to a predetermined image, and user data to be attached to the predetermined image and related to at least one user or all users belonging within the seating chart; and
the first storage procedure causes the computer to inherit and store the data attached to the moved or copied image object, in correspondence with the user data attached to the predetermined image to which the image object is moved or copied and the second window, in response to the update request from the client terminal.

19. The computer-readable storage medium as claimed in claim 17, wherein the user data attached to the seat image stored in the second storage part includes presence information of the user specified by the user data.

20. The computer-readable storage medium as claimed in claim 17, wherein the process further comprises:
a third storage procedure causing the computer to store, in a third storage part of the storage unit, registered user data independent of the user data attached to the seat image stored in the second storage part; and
the registered user data stored in the third storage part includes presence information of a user other than that of the user data attached to the seat image.
